(19) United States
(12) Patent Application Publication
(10) Pub. No.: US 2011/0271230 A1
(43) Pub. Date: Nov. 3, 2011

(54) Visualization and navigation system for complex data and discussion platform

(75) Inventors: Jeffrey L. Harris, Shaker Heights, OH (US); Jeffrey Easter, San Francisco, CA (US)

(73) Assignee: Talkwheel.com, Inc., San Francisco, CA (US)

(21) Appl. No.: 12/799,722

(22) Filed: Apr. 30, 2010

(51) Int. Cl. G06F 3/048; G06F 15/16

(52) U.S. Cl. 715/810; 715/854; 709/204

(57) ABSTRACT

A visualization and navigation technology for complex data sets supports interactive engagement which can result in changes of data in the data sets is suitable for applications providing discussion platforms. A sequence of representations of the node-link structure is presented on a display. Each representation in the sequence includes an upper-level node feature such as a wheel-like construct, intermediate-level node features, and lower-level node features. The upper-level node feature includes a rim. The intermediate-level node features and lower-level node features are positioned on the display along the rim. The lower-level node features and intermediate-level node features are positioned in groups along the rim according to a source parameter. Pointer activated functions are included which cause changes in the representations. A pane for presenting content can be included and linked with the wheel-like construct.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### COMPUTER PROGRAM LISTING APPENDIX

This specification has an Appendix A containing computer code provided on duplicate CD-R disks that have been “finalized” in accordance with 37 C.F.R. §1.52(e)(3)(i). Appendix A contains a HTML and Java language representation of an electronic document with links to scripts. Appendix A consists of a MS-Windows ASCII file “Appendix_A.txt” that is 43,000 bytes (43 kb) in size and was created on 29 Apr. 2010. This Appendix A is part of the disclosure of this invention.

### BACKGROUND

1. Technical Field

The present invention relates to visualization technology supporting interactive navigation of complex data sets such as data sets organizing communications among peers in a network.

2. Description of Related Art

There are many discussion models on the web including social networks, email applications, instant messaging IM applications, and comment/reply type forums. However, group collaboration based on these technologies is cumbersome. As the volume of comments and replies grows in a given subject area, individuals have difficulty following the various threads that can be created.

Social networks are a place for users and groups to come together, share information, interact and make connections. However all social networks still employ out-of-date discussion technology that limits user interactions to one-on-one conversations, and often not even in real-time.

Within organizations, individuals waste countless hours because of the ineffective static means of communication with colleagues. Money is lost, along with diminished productivity. Relevant information is buried in data.

In the education field, more and more classes are conducted over the internet. However online classes are hosted with extremely static, email/forum technology. Active class discussion is almost impossible, and so student participation is low.

There are millions of articles and blogs on the web which can be enlivened by commenting systems. However current commenting systems are set up in such a way that individuals make one comment and never come back.

Many of the difficulties encountered in discussion models arise because of the complexity of the data in addition to the content that must be tracked to stay engaged with a broad conversation. For example, it is necessary to track the timing or freshness of comments, the source of comments, the context in which the comments are made, and links between comments.

Of course, complex data sets are not unique to discussion models. For complex data systems, tools that enable individuals to visualize relationships among the data have been developed. However, these visualization tools have not been effectively applied to the data sets generated within discussion models, or other data sets having similar character.

It is desirable therefore to provide data structures and visualization tools that can facilitate group oriented conversation, can be operated to maintain real-time interaction, and overall can improve communications among groups of users in a network environment.

### SUMMARY

A technology is described for visualization and navigation of complex data sets in support of interactive engagement by users which can result in changes of data in the data sets, and which is suitable for applications providing discussion platforms. Representations of the data are provided that map relationships among the data elements in order to establish usable links between the data elements, and provide easy to follow constructs for interacting with and navigating within the data sets.

The technology includes the method executed by a data processor. The method includes obtaining node-link data defining a node-link structure, for example by retrieving it from a server or another data source. The node-link structure includes at least an upper-level node, an intermediate-level node and a lower-level node, and links relating at least two of the nodes. At least the intermediate and lower-level nodes have a source parameter indicating a source of data in the node. On a discussion platform, an upper-level node may comprise a “topic” of a conversation, a publication or other item which may be of interest to a group of participants in the discussion platform. An intermediate-level node may comprise a “comment” related to the topic or the publication made by a specific participant or user of the discussion platform. A lower-level node may comprise a “reply” to a comment by a specific participant or user of the discussion platform.

The method includes using the node-link data to present a sequence of representations of the node-link structure on a display. The sequence of representations can be related such that sequence begins with a first representation and ends with a last representation, and the last representation is perceptible as a changed continuation of the first representation. Each representation in the sequence includes an upper-level node feature such as a wheel-like construct, which is perceptible on the display representing an upper-level node, one or more intermediate-level node features perceptible on the display representing respective intermediate nodes, and one or more lower-level node features perceptible on the display representing respective lower-level nodes. The upper-level node feature includes a rim. The one or more intermediate-level node features linked to the upper-level node have centers of area positioned on the display along the rim. Likewise, one or more lower-level node features are linked to corresponding intermediate-level node features and have centers of area positioned on the display along the rim. The lower-level node features and intermediate-level node features are positioned along the rim according to a source parameter, so that intermediate-level node features and lower-level node features representing nodes in the node-link structure having a particular source parameter are perceptible as a group positioned along the rim on the display.

At least one representation sequence can include at least one link feature perceptible on the display representing a link between a particular lower-level node and a particular intermediate-level node. The link feature has a proximal end positioned at one of: near the lower-level node feature representing a particular lower-level node, or near the group, if any, of which the lower-level node feature is a member. The link feature has a distal end positioned at one of: near the intermediate-level node feature representing the particular intermediate-level node, or near the group, if any, of which the intermediate-level node is a member.

The representations of the data set can be presented alone, or in combination with navigation tools. Users of the navigation tools can rely on the mapping presented by features on the representations of the data set to inform decisions about threads to follow as the user traverses the data set.

The method can include a navigation tool by providing with at least one representation in the sequence that includes the link feature, a pointer activated function associated with one or more of said intermediate-level node features and lower-level node features, which upon activation over a particular intermediate or lower-level node feature associated with the link feature, causes presentation of another representation sequence in which the link feature is changed highlighting the link represented by the link feature.

At least one representation in the sequence can include a group feature representing a group including a number N of intermediate-level node features and lower-level node features positioned on the rim, where the group feature is perceptible on the display as covering an arc along the rim indicative of the number N. The number N can be indicated by for example, representing the relative magnitude of N relative to the numbers of members in other groups represented on the rim. The method can include providing a pointer-activated function associated with the group feature, which upon activation over the group feature, causes presentation of another representation in the sequence in which the group feature is replaced by the number N of intermediate-level node features and lower-level node features grouped along the rim.

In embodiments described here, the node-link structure can include at least one additional level node having a source parameter, and being linked to a particular lower-level node. In such embodiments, at least one representation in the sequence includes an additional level node feature representing the additional level node, and having a center of area positioned on the display along the rim according to the source parameter, and perceptible as being a member of a group including one or more lower-level node feature and intermediate-level node feature, and positioned along the rim on the display.

The method can include providing, with at least one representation in the sequence, an interface for creating post requests by which updates to the node-link structure may be requested. In addition, method may include causing an update to the node-link structure in response to a post request created using the interface, and to cause presentation of another representation in the sequence including a feature corresponding to the update.

Also in embodiments described here, at least one representation in the sequence includes a graphical construct comprising a pane corresponding with the upper-level node, and fields within the pane corresponding with one or more of the intermediate-level nodes and lower-level nodes. The fields within the pane include representations of the contents, such as text, of the corresponding nodes, and facilitate interaction with a discussion platform for example or with other platforms used for interacting with a node-link structure in a manner that changes the contents of the node-link structure.

The method can include providing along with representations that include the graphical construct comprising a pane, a pointer activated function associated with one or more of said intermediate-level node features and lower-level node features on the representation. Such pointer activated function upon activation over a particular intermediate or lower-level node feature, causes presentation of another representation in said sequence, in which a feature of one of the fields within the pane is changed, such as to highlighting the field, where the changed one of the fields corresponds with the particular intermediate or lower-level node feature.

The method can include providing, with at least one representation in the sequence, a pointer activated function associated with the upper-level node feature, which upon activation causes presentation of another representation in the sequence including a graphical construct comprising a pane corresponding with the upper-level node represented by the upper-level node feature. The pane may include fields corresponding with one or more of the intermediate-level nodes and lower-level nodes linked to the corresponding upper-level node, with representations of the contents of the corresponding nodes.

A computer system is described that includes a data processor with memory and a communication interface, where the memory stores instructions are executable by the data processors that include logic in support of the method described above including electronic documents. The computer system can support a client-server system, where the server maintains the node-link structure and delivers electronic documents to the client in support of implementing the methods described here.

In embodiments of the technology, the electronic documents can include markup language instructions and embedded scripts of instructions executable by a computer, such as a computer executing an Internet browser. Embedded scripts in the electronic documents can be included by inserting links to the scripts, and by including some of all of the scripts themselves. The executable instructions in the electronic documents are adapted to implement the methods described here.

The technology described herein is particularly adaptable to provide an intuitive discussion model built to facilitate group oriented conversations within a user base.

The technology described herein, as applied to a discussion platform, can fill the niche in organizations where instant message and email fail, by improving communication with internal community and keeping instant real-time contact among multiple coworkers working on the same project, enabling seamless discussion of issues or topics within an organization in privacy.

The technology described herein, as applied to a discussion platform, can provide large organizations a capable discussion model to bring all their members together, and improve communication with external community.

The technology can be used to form outside focus groups with customers/website visitors to consider subjects of interest to an organization, such as the feasibility of a new product or service. The technology can provide a real-time classroom dynamic discussion model to conduct online classes, offering a place to continue class started discussions to promote discussions within the student body. The technology can provide a real-time discussion model to facilitate continued conversations sparked by these blogs and articles.

Other aspects and advantages of the present invention can be seen on review of the drawings, the detailed description and the claims, which follow.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a simplified diagram of a computer environment suitable for implementation of the visualization and interaction tools described here.

FIG. 2 illustrates a node-link structure arranged as a hierarchical tree.

FIG. 3 is an image of a representation of a node-link structure based on a wheel-like construct representing an upper-level node feature and graphical construct including a pane, as described herein.

FIG. 4 is an image of a representation of a graphical construct including a pane having an expanded field corresponding to an intermediate-level node.

FIG. 5 is an image of a representation of a graphical construct including a pane having a collapsed field corresponding to an intermediate-level node.

FIG. 6 is a simplified flowchart of an animation loop for generating a sequence of representations as described herein.

FIG. 7 is a simplified flowchart of a process for creating a feature, such as a wheel-like construct, representing an upper-level node as described herein.

FIG. 8 is a simplified flowchart of a process for creating a user object, and arranging lower-level and intermediate-level node features along a rim on the upper-level node feature as described herein.

FIG. 9 is a simplified flowchart of a process for creating a forum object, and creating features on a representation of the node-link structure corresponding to a plurality of upper-level nodes.

FIGS. 10A-10C illustrate changed representations of panes in a graphical construct, with web form buttons used for pointer activated functions associated with the representation.

FIGS. 11A and 11B illustrate changed representations of panes in a graphical construct showing pointer activated functions used for opening a web form used for creating a request to post new intermediate-level node data to the node-link structure.

FIGS. 12A and 12B illustrate changed representations of panes in a graphical construct showing pointer activated functions used for opening a web form used for creating a request to post new lower-level node data to the node-link structure.

FIGS. 13A and 13B illustrate changed representations of a node-link structure including a wheel-like construct and a graphical construct including a pane, with pointer activated functions used for opening an upper-level node structure.

FIGS. 14A and 14B illustrate changed representations of a web form used for creating a new upper-level node for a node-link structure.

FIGS. 15A and 15B illustrate changed representations of a web form used for creating a new intermediate-level node.

FIGS. 16A and 16B illustrate changed representations of a web form used for creating a new lower-level node.

FIGS. 17A and 17B illustrate changed representations of a graphical construct including a pane having an expanded intermediate-level node field and a collapsed intermediate-level node field, respectively.

FIGS. 18A and 18B illustrate changed representations which result from a pointer activated function to highlight a specific node on the wheel-like construct and on the graphic construct including the pane.

FIGS. 19A and 19B illustrate changed representations of the node-link structure resulting from addition of a node to the node-link structure.

FIGS. 20A and 20B illustrate changed representations of the graphical construct including the pane related to the web form used for creating a request for posts of new data.

FIGS. 21A and 21B illustrate changed representations of the wheel-like construct which result from a pointer activated function causing addition of user avatars.

FIGS. 22A and 22B illustrate changed representations of the node-link structure which result from a pointer activated function to cause addition of the graphical construct including the pane.

FIGS. 23A and 23B illustrate changed representations of the node-link structure which result from a pointer activated function to display information about a user.

FIGS. 24A and 24B illustrate changed representations of the node-link structure, which result from a pointer activated function to highlight a group on the wheel-like construct.

FIGS. 25A-25D illustrate changed representations of the node-link structure, which result from pointer activated functions to expand group features into corresponding pluralities of node-level features, and in which the last representation is perceptible as a changed continuation of the first.

FIGS. 26A and 26B illustrate changed representations of the node-link structure, which result from pointer activated functions to highlight a node feature on the wheel-like construct.

### DETAILED DESCRIPTION

A detailed description of embodiments of the technology is provided with reference to the Figures.

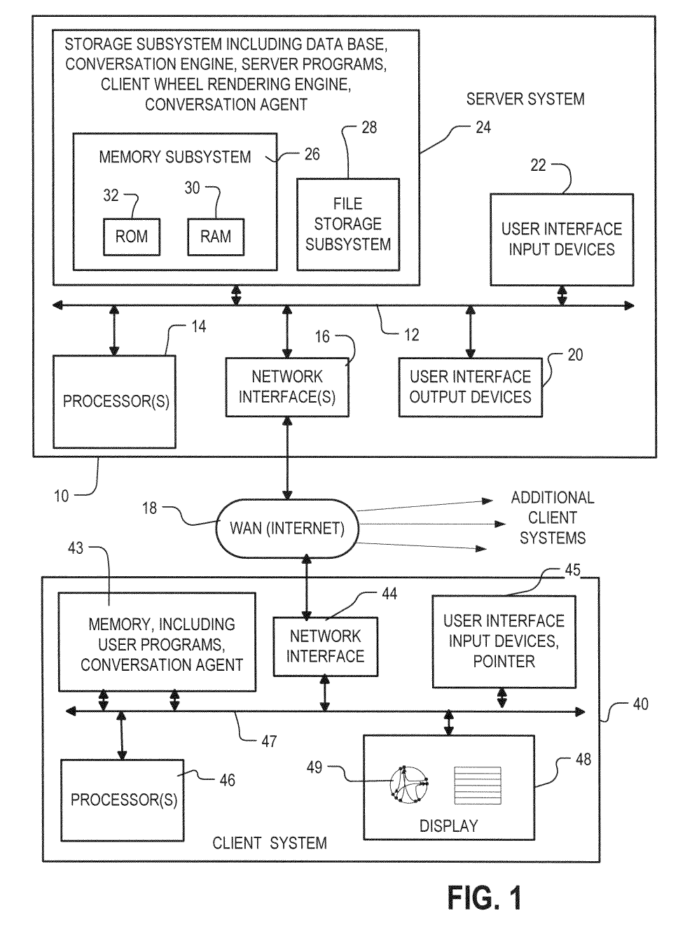

FIG. 1 is a simplified block diagram of a network including computer system 10 hosting server applications, and computer system 40 hosting client applications adapted for embodiments of the technology. Computer system 10 typically includes a processor (or processors) 14 which communicates with a number of peripheral devices via bus subsystem 12. The peripheral devices may include a storage subsystem 24, comprising a memory subsystem 26, including for example ROM 32 and RAM 30, and a file storage subsystem 28, user interface input devices 22, user interface output devices 20, and a network interface subsystem 16. The input and output devices allow user interaction with computer system 10, and typically include a graphical user interface. Network interface subsystem 16 provides an interface to outside networks, including an interface to a wide area communication network 18 in communication with the Internet, and is coupled via communication network 18 to corresponding network interface devices in other computer systems.

User interface output devices 20 may include a display subsystem, a printer, a fax machine, and non-visual displays such as audio output devices. The display subsystem may include a cathode ray tube (CRT), a flat-panel device such as a liquid crystal display (LCD), a projection device, touch screen displays or some other mechanism for creating a visible image and supporting a graphical user interface.

Storage subsystem 24 stores the basic programs of instructions and data constructs that provide the functionality of some or all of the data structure visualization and interaction tools described herein, including the software modules including server applications (including web server applications), serialization and validation systems, accounting, authorization and authentication systems, caching frameworks, support for middleware applications, testing interfaces, communication drivers, database functions for storing and organizing node-link structures, website maintenance functions, software platforms (development tools, compilers, utilities, etc.) and programs based on such platforms. One system can be based on a Django/Python framework and Java-based technologies, including JSON and MySQL based data structures, Java scripts, Raphael objects, jQuery libraries, AJAX protocol drivers, a variety of supporting class libraries and so on. The storage subsystem 4 also stores electronic documents such as web pages expressed in markup languages like HTML, xHTML, XML and others for delivery to client browsers or other interface applications. The electronic documents can include embedded scripts, being embedded by providing links in the electronic document which are executed by a browser or other application that parses the electronic document, or by including the script within the electronic document. Additional functions can be provided, including for example, support for the OpenSocial API for an Internet based discussion platforms, email systems, instant messaging systems, and other user and machine interaction protocols.

Computer system 40 typically hosts client applications, and includes a processor (or processors) 46 which communicates with a number of peripheral devices via bus subsystem 47. The peripheral devices may include a memory 43, user interface input devices 45, user interface output devices including a display 48, and a network interface subsystem 44. The input and output devices allow user interaction with computer system 40, and include a graphical user interface displaying wheel-like constructs 49 acting as representations of the node-link structures stored in the server side system 10. Network interface subsystem 44 provides an interface to outside networks, including an interface to a wide area communication network WAN 18 in communication with the Internet, and is coupled via communication network 18 to corresponding network interface devices in additional client side computer systems. User interface input devices 245 may include a keyboard, a mouse, trackball, touchpad, or graphics tablet, a scanner, a touch screen incorporated into the display, audio input devices such as voice recognition systems, and other types of input devices which can be used as a pointer to select a position on an image shown in the display, and be used in activation of pointer activated functions. In general, use of the term “input device” is intended to include all possible types of devices and ways to input information into computer system 10 or onto communication network 18.

User interface output devices in addition to display 48, may include a printer, a fax machine, or non-visual displays such as audio output devices. The display 48 may include a cathode ray tube (CRT), a flat-panel device such as a liquid crystal display (LCD), a projection device, touch screen displays or some other mechanism for creating a visible image and supporting a graphical user interface usable by a designer.

Memory 43 stores user programs including conversation agents like Internet browsers, email clients, instant messaging clients, electronic documents such as web pages, and other programs complementing the server side programs. In systems based on Java scripts and other Java based technologies, the memory 43 stores programs establishing a Java virtual machine.

The embodiment illustrated here suggests that the server side system 10 includes data processing resources typical in large scale Internet servers and web site hosting systems. In alternative systems, the server side applications may be executed on a personal computing device or other processing platform. Also, server side processing resources may also include client side communication agents, allowing participation in the system by users or applications running in the server system 10. Also, the client computer systems can include smart phones and other similar platforms capable of executing a graphical user interface as described here.

The technology described herein can be applied for implementation of an Internet-based discussion platform, according to which a webpage is generated and delivered to clients enabling visualization at client devices of an ongoing discussion. The processing supporting the discussion platform can be distributed between the server side resources and the client side resources, where scripts provided to the client browser or native programs loaded in the client computer enable use of client side resources as needed.

The discussion platform comprises a database maintained in memory accessible by the server that includes posts by clients which can be related by node-link structures in the database including at least three levels as described in more detail below.

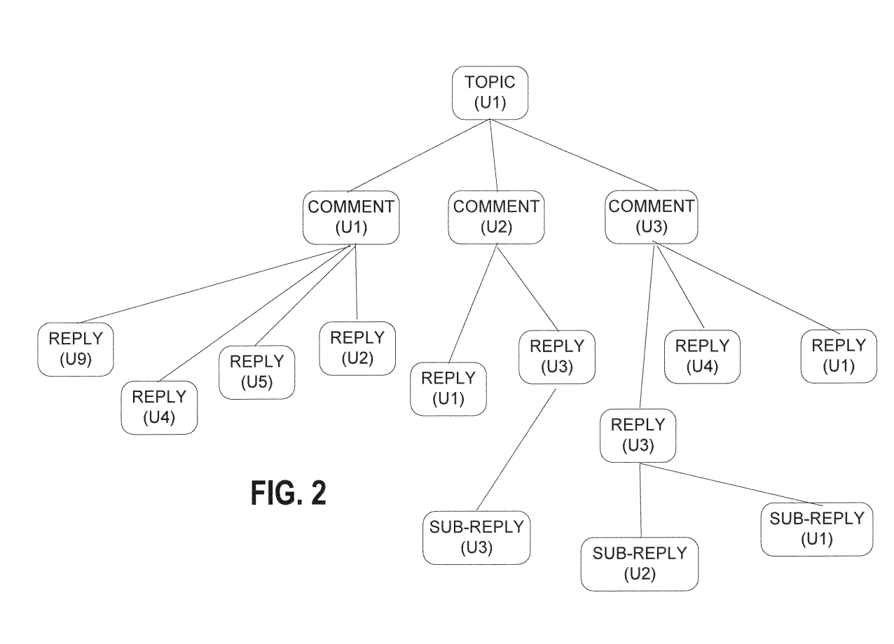

The discussion platform includes records in the database identifying users and “conversations.” The database maintains parameters associated with the users by which the system grants access to one or more conversations based on authentication and authority parameters. The database maintains information identifying conversations in which the users have signaled a desire or have been authorized to participate. Data supporting conversations can be maintained in the discussion platform according to a node-link structure such as is illustrated in a simplified form in FIG. 2. In the organization shown in FIG. 2, a top-level node identifies a topic of a conversation where a topic may be posted by a user or from an administrator for example. An intermediate-level node identifies a comment posted by a user and linked to the topic. As shown in the Figure, comments are maintained in the structure from users U1, U2 and U3. A lower-level node identifies a reply posted by a user and linked to a comment. As shown in FIG. 2, replies posted by users U9, U4, U5 and U2 and linked to the comment by user U1; replies posted by users U1 and U3 and linked to the comment by user U2; and replies posted by users U1, U3 and U4 and linked to the comment by user U3, are illustrated. Additional levels in the node-link structure can include for example sub-replies posted by a user and linked to a reply. As shown in FIG. 2, sub-replies posted by users U3, U2 and U1 and linked to a reply by user U3 are shown. One notes that the node-link structure shown in FIG. 2 is represented as a hierarchical tree. In other examples, the node-link structure need not be a strictly hierarchical tree.

A discussion platform of the type represented in FIG. 2 can be executed with a number of users in the group, such as 30 or more, participating in a conversation over an interval of time, such that the node-link structure maintaining the database is updated at random times. The nodes in the node-link structure therefore can include content such as the text of a topic, a comment, a reply or a sub-reply, a parameter identifying the user who generated the post request which led to creation of a node in the node-link structure, a parameter identifying a time at which the post was requested by the user or accepted for entry into the node-link structure and other parameters useful for participation in and management of the conversation. It can be appreciated that as the number of conversations, the number of posts and the number of users grows, navigating an interface used for participation in the conversations can become difficult.

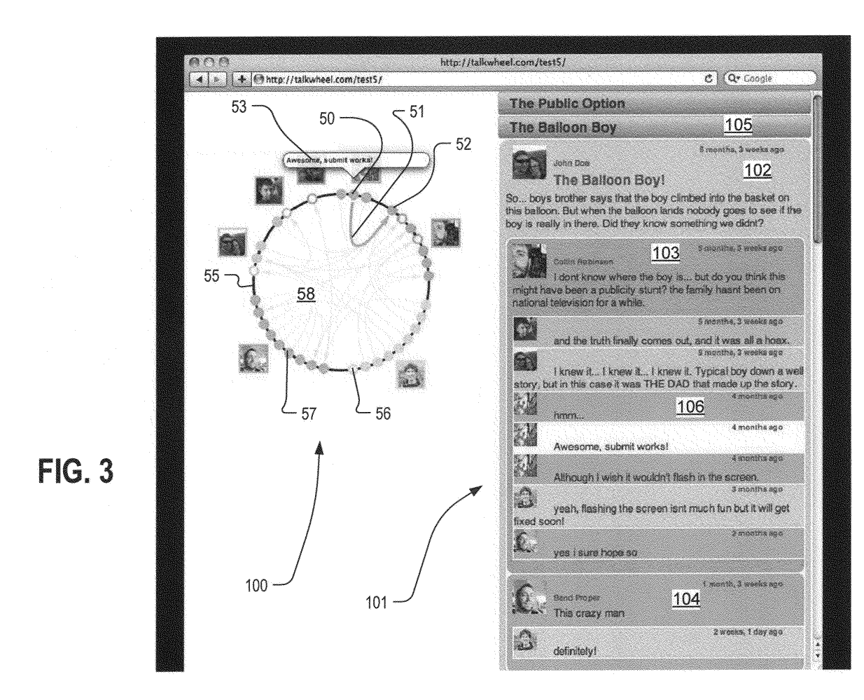

FIG. 3 is an image of a representation of a node-link structure supporting a conversation as described above, in which a wheel-like construct 100 (which comprises a feature in the representation) is used to display information about the node-link structure in a manner usable by a person viewing the construct. The wheel-like construct 100 includes a circular rim 55 in the illustrated example. It need not be circular. The wheel-like construct may include a rim 55 that is elliptical, polygonal, or have other shapes. The rim 55 in the illustrated wheel-like construct is continuous and smooth, but may be in other embodiments crenate, crenellated or otherwise irregular in outline. Also, embodiments may include a discontinuous feature representing the rim 55, which is discontinuous in one place as in a “c”-shaped or horseshoe-shaped rim, or in plural places around the rim. Also, the rim 55 is visually represented in the illustrated example by a line. In some embodiments, the wheel-like construct may not include a representation of the rim visible in the image. Features can be positioned along the rim in a manner that suggests the presence of the rim, with or without a visible line representing the rim. Also, the features on the representation can be rendered in a three dimensional manner that shows depth. Features representing nodes on the rim can be positioned so that they appear to be equidistant from a center of the rim, or may be positioned in a manner that allows for variation in distance from the center of the rim if desired.

A forum pane 101 is presented as a feature in the representation along with the wheel-like construct 100. The forum pane 101 need not be displayed in all representations including the wheel-like construct, and vice versa. The representation can be delivered in combination with hyperlinks, hover and click interaction scripts, and web form constructs (buttons, text entry fields, radio buttons, checkboxes, etc.) to facilitate interaction between a client and a server, and to support creation and submission of post requests by the users.

In the example shown, the forum pane 101 shows two conversations including open conversation 105 entitled “The Balloon Boy!”, with the topic level post (e.g. 102) in the conversation presented as a topic field including nested comments (e.g. 103, 104), nested comments presented in comment fields including nested replies (106). Nested replies can be presented in reply fields including nested sub-replies. Alternatively, sub-replies may be presented using representations similar to those used to represent a reply field, nested within a comment field.

The icons comprising colored dots on the wheel-like construct are examples of features representing corresponding posts. Other shapes may be used, including stars, squares, polygons, and so on. Individual users may be assigned individualized icons for use in representing posts made by them. As shown in FIG. 3, the feature representing posts (dots) have centers of area positioned along the rim. Features representing posts made by a given user are positioned in a group along the rim 55 of the wheel-like construct 100 and color-coded. Open dots (e.g. 56), or other types of icons, can be features used to represent comment level posts, while closed (or filled) dots (e.g. 57), or other types of icons that are different from the icons used for comment level posts, can be features used to represent reply level posts and sub-reply level posts.

Arrows between the features representing posts in the region 58 can be used to show links between nodes or groups of nodes.

In the example in FIG. 3, there are seven groups of icons corresponding to posts by seven different users. Associated with each group of icons, and outside the rim of the wheel features are positioned such as the illustrated graphic avatars, which correspond to the user responsible for the posts in the adjacent group. In the illustrated example, the results of a user interaction selecting node 50, such as a hover of a pointer on a graphic interface displaying the wheel-like construct, are illustrated, including highlighting of an arrow 51 showing the relationship between the node 50 and its parent node 52, and display of a “text balloon” 53 including an excerpt or snippet from the post 50.

Color is used visualize the connection between posts on the wheel-like construct and posts in the forum. The wheel/forum relationship is also shown through highlighting actions. When the user moves the mouse over a post on the wheel-like construct, the corresponding post is highlighted on the forum and vice versa. When clicking on a post on the wheel-like construct, the forum is scrolled to that post. Simple styling throughout can be applied to emphasize the pieces of information the user needs to see. On the forum, posts wrap around the child posts to represent the nesting. This helps the user to know how the posts are nested. Arrows on the wheel show the relationship between posts. This relationship can be non-linear and these arrows may show the connections between many items at the same time.

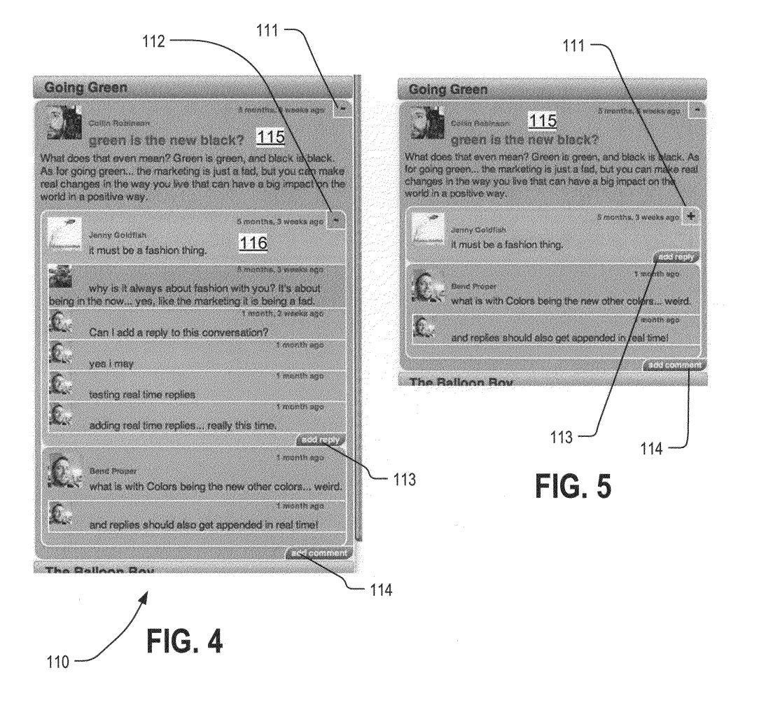

FIG. 4 is an image of a forum pane 110 with web form buttons added to the image. Thus, a minimize button 111 is placed in the upper right corner of the topic field 115 within the pane. Also, a minimize button 112 is placed in the upper right corner of the comment field 116. An “add reply” button 113 is placed in the lower right corner of a comment field 116. An “add comment” button 114 is placed in the lower right corner of the topic field 115. FIG. 5 illustrates the forum pane 110 after the threads within comment field 116 have been collapsed by clicking on the minimize button 112. Minimizing the threads within a comment field allows a large number of posts to be accessible in the forum pane with a minimal increase in the complexity presented to the user.

The wheel-like construct, with or without the forum pane, described herein can be used for a variety of types of node-link data other than the conversation type data described in this example. For another example, node-link data representing communications among applications like servers in a communication network performing a coordinated function suitable for representation in a node-link structure, could be represented in this way. Other types of data can be represented as described herein, where analytic relationships among nodes are highlighted in a manner that allows monitoring of activity represented by or relating to the data in the nodes, or allows for correlating data stored in nodes. For example, a node link structure can represent a catalog of products on an e-commerce system, results of searching, outputs of physical sensors, etc. The visualization and navigation tools clearly map out relationships of data and enable uses in visualizing trends in the data.

The following conceptual framework is helpful in understanding the broad scope of the invention, and the terms defined below have the indicated meanings throughout this application, including the claims.

An “image” is a pattern of physical light. An “image output device” is a device that can provide output defining an image. A “display” is an image output device that provides information in a visible form. A display may, for example, include a cathode ray tube; an array of light emitting, reflecting, or absorbing elements; a structure that presents marks on paper or another medium; or any other structure capable of defining an image in a visible form.

To “present an image” on a display is to operate the display so that a viewer can perceive the image.

When an image is a pattern of physical light in the visible portion of the electromagnetic spectrum, the image can produce human perceptions. The term “graphical feature,” or “feature,” refers to any human perception produced by, or that could be produced by, an image.

A “pointer” is a graphical feature that indicates a position within an image. A pointer is “at a position” when the pointer is indicating the position.

An image “shows” or “includes” a feature when the image produces, or could produce, a perception of the feature.

A “node-link structure” is a structure that includes items called nodes and links. Each link relates two or more of the nodes. Two nodes are “related through one link” or “related through a link” if the node-link structure includes a link that relates the two nodes. A link “relates a pair” of nodes if the link relates only two nodes.

A “graph” is a node-link structure in which each link relates two nodes. An “acyclic graph” is a graph in which there are no loops of edges. A “directed graph” is a graph in which each link indicates direction between the nodes it relates, with one node being a source of the link and the other being a destination. A “tree” is an acyclic directed graph with exactly one root node such that every other node in the tree can be reached by only one path that begins at the root node and follows each link in the path in its indicated direction.

A “branch” of a node-link structure is a set of nodes that forms a tree within the node-link structure if the links are treated as relating pairs of nodes and as indicating direction. A branch therefore includes two or more levels, with the “top level node” being the node that is the root node of the tree formed by the branch, and “lower-level nodes” being nodes at one or more levels of the tree below the top level node. Each lower-level node has a “parent node” at the next higher level to which the lower-level node is related through one link. A parent node has a set of “child nodes” at the next lower-level to each of which the parent node is related through one link. The child nodes of a parent “share” the parent node.

An item of data “defines” a node-link structure if the item of data includes information indicating how the links relate the nodes. For example, the item of data could include, for each link, an identifier of each of the nodes that it relates.

An item of data defining a node-link structure includes “content” if the item of data includes information about nodes or links other than information indicating how the links relate the nodes. For example, the item of data could include a name or other descriptive information for a node or for a link.

A graphical feature “represents” a node-link structure when the graphical feature itself includes features that map or correspond with a set of nodes and links in the node-link structure.

A feature that maps or corresponds to a node “represents” the node and a feature that maps or corresponds to a link “represents” the link. A “node feature” is a feature that represents a node, and a “link feature” is a feature that represents a link.

A “graphical representation” or “representation” is a graphical feature that includes elements that are spatially related in a configuration that represents information.

A “sequence of representations” is a sequence that includes at least two representations. A sequence of representations begins with a “first representation” and the first representation is followed by a “sequence of at least one following representation” that ends with a “last representation.” Each following representation follows a “preceding representation.”

A sequence of representations may also include one or more “intermediate representations” between the first and last representations. A sequence of representations may include a “subsequence of representations” that is also a sequence of representations as defined above.

A second display feature is perceptible as a “continuation” of a first display feature when presentation of the second display feature follows presentation of the first display feature in such a way that the user perceives the first display feature as being continued when the second display feature is presented. This can occur when the successive display of two display features is so close in time and space that they appear to be the same display feature. An example of this is the phenomenon called “object constancy.”

The last representation of a sequence of representations is perceptible as a “changed continuation” of the first representation when the last representation is perceptible as a continuation of the first representation but with at least one change. An intermediate representation is similarly perceptible as an “intermediate changed continuation” of the first representation when the intermediate representation is perceptible as a continuation of the first representation but with at least one change.

An “animation loop” is a repeated operation in which each repetition presents an image and in which features in each image appear to be continuations of features in the next preceding image. If a user is providing signals through user input circuitry, the signals can be queued as events and each loop can handle some events from the queue. An “animation cycle” is a single iteration of an animation loop.

The “detail” with which an image is presented is the quantity of information in the presented image. Information in an image can be increased by providing additional lines or objects, by providing arcs rather than straight lines, and so forth. A “level of detail” is a value indicating one of a set of quantities of information in an image.

Speed of presentation of images is “maintained” when a sequence of images is presented without a reduction in speed of presentation.

A sequence of images is presented at a sufficient speed that features in the images are perceptible as a “continuously moving feature” if the images can provide the perception of a single feature that moves, and may also evolve, rather than the perception of a sequence of distinct features presented in succession. Such a speed is sometimes referred to as an “animation speed.”

An operation includes a “sequence of iterations” when the operation includes a sequence of substantially similar sub-operations, each referred to as an “iteration,” where each iteration after the first uses starting data produced by the preceding iteration to obtain ending data. Each iteration's ending data can in turn be used by the following iteration.

An item of data “defines” a representation when the item defines an image that includes the representation. A representation “is presented” when an image that includes the representation is presented. Providing data to a display “causes” presentation of a representation or sequence of representations when the display responds to the data by presenting the representation or sequence of representations.

A “region” of a representation is a bounded area of the representation; for example, a single point is the smallest possible region of any representation. A representation “includes” a feature or a region if presentation of the representation can produce perception of the feature or region.

A “representation of a node-link structure” is a graphical representation that represents the node-link structure. In a representation of a node-link structure, for example, link features can be lines, such as arcs or straight lines, that extend between node features. A representation of a node-link structure may also include graphical features that “indicate” content, such as words or other strings of characters from which a viewer can obtain information about a represented part of the structure.

A representation of a node-link structure is “perceptible as a figure on a background” if the representation includes a feature, referred to as the “figure,” and the feature appears to be on or above a region that is not part of the figure, referred to as the “background.”

A “bounded-node feature” is a node feature that has a perceptible boundary. The “center of area” of a bounded-node feature is the center of area of the region within the node feature's boundary. The position of a bounded-node feature's center of area can therefore be computed from the node feature's boundary or estimated by viewing the representation.

The “nearest other node feature” of a first bounded-node feature in a representation is a second bounded-node feature whose center of area is spaced from the first node feature's center of area by a distance no greater than the spacing from the first node feature's center of area to any other bounded-node feature's center of area. A bounded-node feature may have more than one nearest other node feature, all with centers of area at the nearest node spacing. A bounded-node feature has a position and a node region around the position centered at the node feature's center of area. The node region around the position has an area assigned for display of a representation of the node on the display.

The “area of,” or the “area enclosed by,” a part of the representation is a measure of the part's two-dimensional extent.

Centers of area of node features in a representation are “positioned approximately along a line or along an arc” if a line or arc can be drawn within the representation such that each node feature's center of area is closer to the line than to an adjacent node feature's center of area.

Features whose centers of area are positioned approximately along a line or arc are perceptible as a group of related features, if the node features together appear to a viewer to be a group.

A Java-based implementation of a discussion platform having programs of instructions that can be applied to implement visualization tools and supporting tools is described here. As mentioned above, the technology can be implemented in a wide variety of platforms other than Java. In the implementation described here, the server maintains a discussion platform which includes in this example, a JSON database and an Open Social application program interface API to support the posting of topics, comments and replies as discussed above. Java scripts are included in markup language such as HTML, xHTML, XML and so on, for webpages served by the system. When a user accesses a webpage, an electronic document is retrieved from a computer readable medium such as memory in the storage subsystem in the computer system 10 of FIG. 1, and is delivered to the browser at the user terminal where it is stored in a computer readable medium such as the memory 43 in computer 40 of FIG. 1. The electronic document is a data structure including markup language instructions and embedded scripts of instructions, or links to scripts of instructions, executable by a computer, to implement processes described herein. One example electronic document can be expressed as follows:

START index.html:
<!DOCTYPE HTML PUBLIC “-//W3C//DTD HTML 4.01//EN”
“http://www.w3.org/TR/html4/strict.dtd”>
<html xmlns=“http://www.w3.org/1999/xhtml” xml:lang=“en” lang=“en”>
<head>
<meta http-equiv=“Content-Type” content=“text/html; charset=iso-8859-1” />
<link rel=“stylesheet” type=“text/css” href=“./tw_site.css” />
<script type=“text/javascript” src=“http://code.jquery.com/jquery-1.4.2.min.js”></script>
<script type=“text/javascript” src=“./tw_login.js”></script>
</head>
<body>
<div id=“tw_main” class=“login”>
<div id=“tw_logo”></div>
<!-- <b class=“btop”><b></b></b> -->
<form class=“loginForm” method=“post” action=“”>
<h1>Talk Wheel login</h1>
<p><label for=“id_username”>Username</label> <input id=“id_username” type=“text”
name=“username” maxlength=“30” /></p>
<p><label for=“id_password”>Password</label> <input type=“password”
name=“password” id=“id_password” /></p>
<input class=“login_submit button” type=“submit” value=“login” />
<input type=“hidden” name=“next” value=“” />
<input type=“hidden” name=“ajax” value=“1” />
</form>
</div>
</body>
</html>
END index.html
(Copyright Talk Wheel, Inc. 2010)

This document includes a link to a library used by the scripts, and a link to a login javascript “tw_login.js” The document includes links by references within the referenced scripts, to a sequence of scripts used to produce a sequence of representations of the node-link data.

Upon login the user's browser executes the markup language and scripts to present a representation or a sequence of representations, of the node-link structure. Scripts support a login function and set up of variables, load libraries and so on. Also, scripts are provided to specify functions for opening and drawing the wheel-like construct, opening and drawing the forum construct, and managing user interactions and post interactions with the web page. During the process, an excerpt from the database is retrieved, using an AJAX protocol for example, from the server in a JSON format. Objects are created which correspond to nodes and links in the database, including a “circle object” used for characterizing the wheel-like construct representing a topic level node and user interface interaction with such features, a “post-object” used for characterizing features representing the posts for comment, reply and sub-reply level nodes, and user interface interactions with such features, and a “user object” for characterizing features representing the user and user interface interactions with such features. A Raphael JavaScript library can be used for rendering features of the wheel-like construct and of the forum construct.

After a login and set up operation, a set of functions is used to open and draw a wheel-like construct. An open wheel function sets default parameters for a representation of a wheel-like construct for a particular topic, creates a Raphael object to hold data characterizing the features to be displayed, and retrieves the JSON node data for the topic. The function is executed to draw the wheel, either as a standalone graphic construct, or in combination with the forum. In support of drawing the wheel, a “circle object” is created for the wheel along with an object set which encompasses all of the users participating in the discussion as represented by contents of the nodes and all the posts currently active in the discussion. The functions used to draw the wheel also operate to decide based on the number of posts how to arrange them around the rim of the wheel-like construct. In addition, scripts are provided to facilitate assigning coordinates on the wheel-like construct for features representing posts, features representing users and arrows linking posts, including translating between radial designations of location on the wheel-like construct, and Cartesian designations of location on a display.

Additional functions are provided to set a timer which invokes a reload operation, such as executing an AJAX protocol request to retrieve updated JSON data corresponding to the currently displayed topic. With updated data, functions used to draw the wheel can be re-executed, updating the positioning of features representing posts, users and links. This constitutes an animation loop that results in presentation of a sequence of representations of the node-link structure, where a last representation in the sequence is recognizable as a changed continuation of the first representation in the sequence.

A set of functions is also provided to open and draw the forum pane construct. A forum pane is created for each set of topics of which the user for the webpage is authorized to participate in. The forum pane can include a number of topics which constitute a “conversation.” The draw forum function draws a conversation pane, implements interface actions, and implements re-load actions. The function for drawing a conversation provides markup for creating a representation of a conversation header, and based on permissions associated with the user, and adds web form buttons or other web form constructs to the conversation header. Then, within the conversation, a function is executed to draw topics to be nested within the conversation. The topic is drawn by adding markup for creating a representation of the topic within the conversation pane. Also, a function is provided for drawing comments within a linked topic, which includes adding markup for creating a representation of a comment within the linked topic. An additional function is provided for drawing replies within a linked comment, by adding markup for creating a representation of the replies. Associated with the markup for creating representations of the forum elements, the scripts for hover/unhover events and click events, associated with the representations of the conversation, topics, comments and replies are added. Functions associated with click-type events can include collapse and expand for topic, comment and reply fields, draw the wheel-like construct associated with an expanded selection for a topic, providing input and requesting posts based on the input for topics, comments, replies and sub-replies, along with other interactions suitable for the particular conversation engine being implemented, including invitation posts, join posts, and so on.

Additional functions can be added to support user submissions of requests for posts or other information to the server. In association with a reply/submit button displayed on the screen, a function can be run to send a request to the server to post a reply submission, along with a function associated with redrawing the page based on the new post. Likewise, reply/cancel buttons can be associated with functions that close input fields. Comment/submit buttons can be associated with functions which send a post request to the server to post a comment submission and rerun the functions that draw the wheel. Topic/submit buttons can be associated with functions that send a post request for creation of a new topic at the server.

A representative circle object can be characterized as follows:

Circle object:

object set called semiViz
draw the main circle
if tw_small == true:

draw the transparent scrim circle and hide
draw an invisible circle, add a click event to run function

Circle.clickWheel( ), add a hover event to run function
Circle.smallWheelHovered( ), add an unhover event to run function
Circle.smallWheelUnHovered( )

function Circle.circleToFront( ):

arrange the invisible circle infront of all other objects

function Circle.clickWheel( ):

run function openWheel( )

function Circle.smallWheelHovered( ):

if tw_small == true:

show the scrim circle, set and the avatarViz set
run function Circle.circleToFront( )

function Circle.smallWheelUnHovered( ):

if tw_small == true:

hide the scrim circle, set and the avatarViz set
run function Circle.circleToFront( )

(Copyright TalkWheel, Inc. 2010)

A representative post-object can be characterized as follows:

Post object:

requires id and options object when created (options object is from JSON)
from options, set snippet, children list, parent_post, owner_id
set postXY, postXYTo, postXYFrom as blankXY object
set dom_location as blank object
run function initialize( ):

if a topic post: set post_circle to white
else: set post circle to owner color
create post_circle, set to default attributes, hide it, add hover/unhover

event
(Post.hoverPost( ), Post.unHoverPost( )), add click event (Post.clickPost( ))

if not a topic post: create arrow with default attributes

if tw_small == false: create snippet_bubble with snippet text and default

attributes

function Post.arrangePost( ):

set postXY using function getXYFromRadians with values from

angleArray

set postXYTo using function getXYFromRadians with values from

angleArray

set postXYFrom using function getXYFromRadians with values from

angleArray

update/redraw XY for post_circle using postXY values, show post_circle

function Post.updateArrow( ):

if post is not a topic:

set toXY to parent_post.postXYTo
set fromXY to postXYFrom
update/redraw arrow attributes with toXY and fromXY values

function Post.hoverPost( ):

if post is not a topic:

highlight arrow

for each child:

highlight childs arrow

highlight post in the forum
show snippet_bubble

function Post.unHoverPost( ):

if post is not a topic:

unhighlight arrow

for each child:

unhighlight childs arrow

unhighlight post in the forum
hide snippet_bubble

function Post.clickPost( ):

highlight forum post with a timer to unhighlight after 3 seconds

scroll forum to the forum post location

(Copyright TalkWheel, Inc. 2010)

A representative user object can be characterized as follows:

User object:

requires id and options object when created (options object is from JSON)
from options, set post list, color, name, profile_image_url
set userCenterXYTo, userCenterXYFrom as blankXY object
run function initialize( ):

create arc with default attributes, hide, add hover/unhover

events(User.hoverUserArc( ),
User.hoverUserArc( )), add click event (User.clickUserArc( ))

create avatar with default attributes/border, user color, user image
if tw_small == true: add avatar to avatarViz set (used for showing/hiding

avatars in the
small version of the wheel)

else:

create user_bubble with default attributes
add hover/unhover events to avatar (User.hoverUser( ),

User.unHoverUser( ))

function User.updateArc( ):

based on values from angleArray, update start and end XY coordinates for

the user arc,
redraw/animate to new location

function User.num_posts( ):

return the number of posts belonging to this user

function User.arrangePosts(compression_status):

set userCenterXYTo using function getXYFromRadians with values from

angleArray

set userCenterXYFrom using function getXYFromRadians with values

from angleArray

if compression_status == User.id or −2: (meaning the users posts should be

drawn
individually rather than showing the arc)

hide the arc
for each of the users posts:

show the post
run function Post.arrangePost( )

else:

for each of the users posts:

hide the post
set the postXYTo/postXYFrom to

userCenterXYTo/userCenterXYFrom

show the arc
run function User.updateArc( )

set the avatarXY using function getXYFromRadians with values from

angleArray,
redraw/animate avatar to new location

function User.hoverUser( ):

show user_bubble

function User.unHoverUser( ):

hide user_bubble

function User.hoverUserArc( ):

highlight arc

function User.unHoverUserArc( ):

unhighlight arc

function User.clickUserArc( ):

(this will uncompress this users arc)
run function updateWheelCoordinates(id) (this function will recalculate all

XY
coordinates based on this user being uncompressed)
(Copyright TalkWheel, Inc. 2010)

A representative JSON object can be characterized as follows:

Model:
{

“users” : {

user_id : {

name,
color,
user_id,
posts: list of post_id
profile_image_url
is_online

}

```
  },
  “posts” : {
```

post_id: {

snippet,
post_id
children: list of post_id of children
parent_post,
user_id (owner)

}

},
“conversations” : {

conversation_id : {

conversation_id,
title,
description,
view_privacy,
edit_privacy,
invite_privacy,
state : open
“topics” : {

topic_id : {

topic_id,
conversation_id,
user_id,
time,
title,
text of post,
“comments” : {

comment_id : {

comment_id,
topic_id,
user_id,
time,
title,
text,
“replies” : {

reply_id : {

reply_id,
comment_id,
user_id,
time,
title,
text

} ,

}

}

}

}

}

} ,
conversation_id : {

conversation_id,
title,
description,
view_privacy,
edit_privacy,
invite_privacy,
state : closed

}

}

}
(Copyright TalkWheel, Inc. 2010)

A example of scripts accessed by links from the electronic document described above, and used for rendering the wheel-like construct used to represent an upper level node in the illustrated embodiment, including a “Talkwheel.secondary.js” is set forth in the COMPUTER PROGRAM LISTING APPENDIX, which shows one technology for implementing the electronic document with links to scripts as referred to above.

In alternative implementations, functions supporting the creation of representations of the wheel-like construct and the forum construct can reside at the server, and results of execution of such functions delivered to the clients in graphic format supported by web form and hyperlink structures to invoke data entry and submission, hover-type and click-type interactions. Other distributions between the server and clients of the processing logic can be implemented in a network environment as suits the particular implementation. Also, functions can be executed using native operating system programs executed at the client, rather than virtual machine type programs like these Java-based implementations.

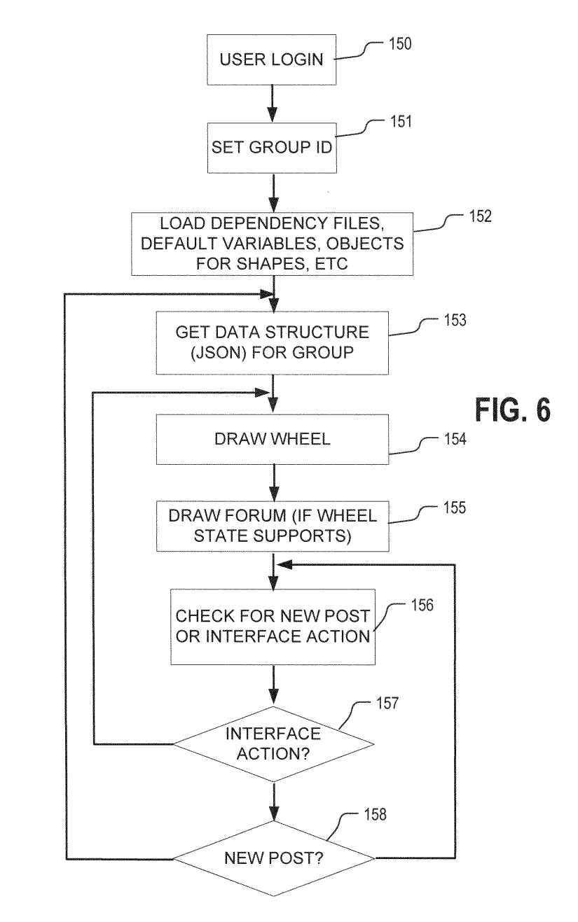

FIG. 6 is a simplified flowchart of an animation loop process for presenting a sequence of representations of a wheel-like construct and forum pane for a conversation engine as described here. A first step occurs at user login 150. Upon successful login, a group ID parameter is set associating a group of conversations with the user (151). Next, dependency files, default variables for animation speeds and objects for the shapes and other data structures and logic constructs are loaded (152). The user browser executes code embedded in the webpage, to retrieve a data structure such as a JSON data structure for the group (153). A function is called to draw the wheel-like construct (154). These functions can maintain state information for the animation loop and provide other coordinating processes. A function is called to draw the forum pane, if the wheel state calls for displaying a forum pane (155).

The process checks for new posts or interface actions created by user input (156). If the process detects an interface action (157), then data structure on the local machine is updated and the algorithm returns to the function for drawing the wheel (154). If a new post is detected (158), then the function returns to step 153, and makes a call to the server to update the data structure, and draws an updated representation of the data structure. As a result of this animation loop, a sequence of representations including the wheel-like construct is created. The animation loop can be executed in manner that obtains changes to the node link data on short intervals of time, such as on the order of one or a few seconds, and creates new representations in the sequence which reflect in changes in the node-link data at a speed that can be characterized as “real time” from the point of view of a person viewing the sequence of representations. As a result, after presenting at least one representation in the sequence, a change in the node-link data is obtained, and a representation is produced in the sequence made by the animation loop that includes at least one of: an additional lower-level node feature positioned along the rim, and an additional intermediate-level node feature positioned along the rim and representing the change in the node-link data. The animation loop produces a sequence of representations on the display, which begins with a first representation and ends with a last representation, the last representation being perceptible as a changed continuation of the first representation.

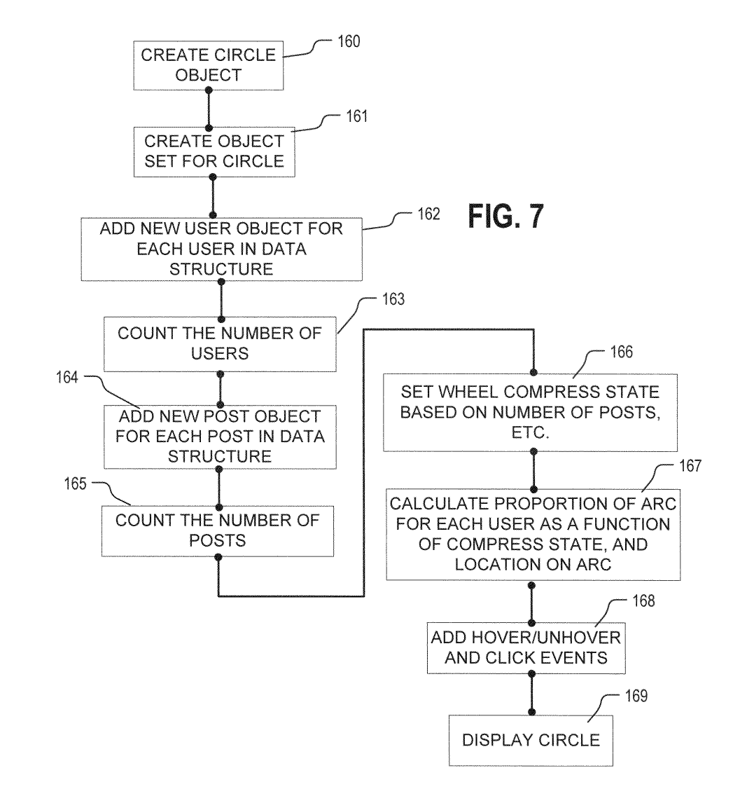

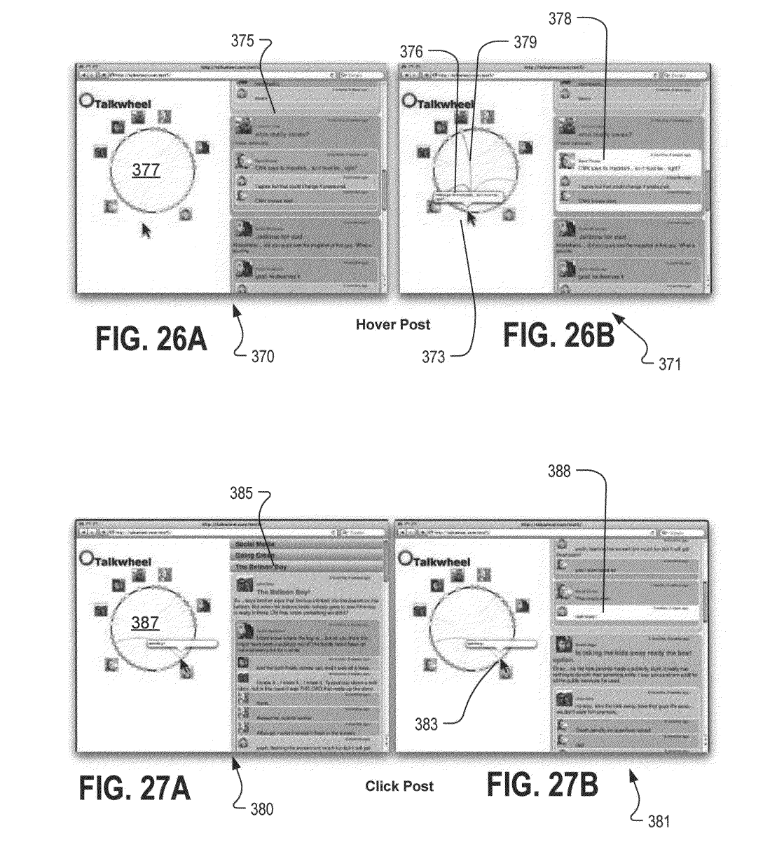

FIG. 7 is a representation of a Circle object, with embedded functions. The create function is provided to create a Circle object for a topic (160). Next, a function is provided to create an object set for the circle using default and empty values (161). A new user object is added for each user in the data structure associated with this topic (162). A function is included for counting the number of users (163). A function is included for adding a new post object for each post in the data structure (164). A function is included for counting the number of posts (165). A function is included for setting the wheel compression state based on the number of posts and the number of users (166). A compression state determines whether a group feature, such as the compressed user arc feature described below (See FIGS. 26A-26D), representing a plurality of posts associated with a given user is to be displayed on the rim of the wheel, or features corresponding to individual posts of the user are to be displayed. A function is included for calculating a proportion (arc) of the rim for each user as a function of the compression state and to assign a location on the rim (167). A function is included for adding hover/unhover events associated with the circle (168). A function is included for displaying the circle (169).

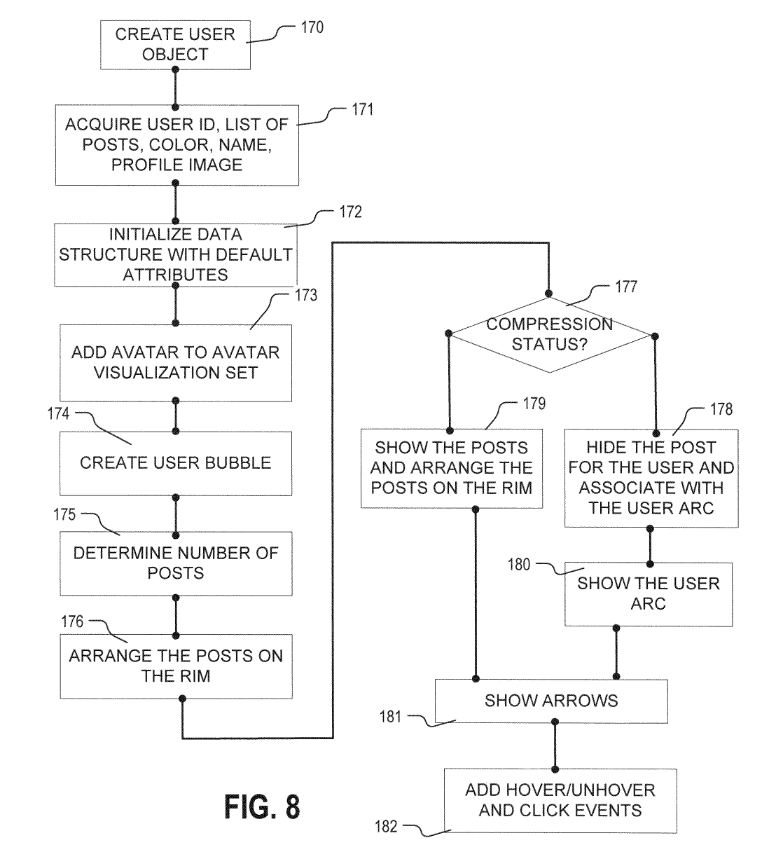

FIG. 8 is a representation of a user object. The user object includes a function for creating user object (170). A function is included for acquiring a user ID, a list of posts for the user, a color for representations of the user, a name and a profile image (171). A function is included for initializing a user data structure with default attributes (172). A function is included for adding an icon or avatar to an avatar visualization set containing users associated with the wheel (173). A function is included for creating the user bubble feature with default attributes (174). A function is included for determining the number of posts associated with the user (175). A function is provided for arranging the posts on the rim (176). The function is included for determining the compression status for the user on the wheel (177). If the compression status requires display of a group feature, such as a compressed user arc feature, then the individual posts by the user associated with the group feature are hidden (178) and the compressed user arc feature corresponding to the group is shown (180). For the case in which the compression status requires showing individual posts, a function is provided for showing the posts and arranging the posts on a portion of the rim associated with the user (179). A function is provided for locating and showing arrows associated with the posts (181). A function is provided for adding hover/unhover events and click events associated with the user object (182).

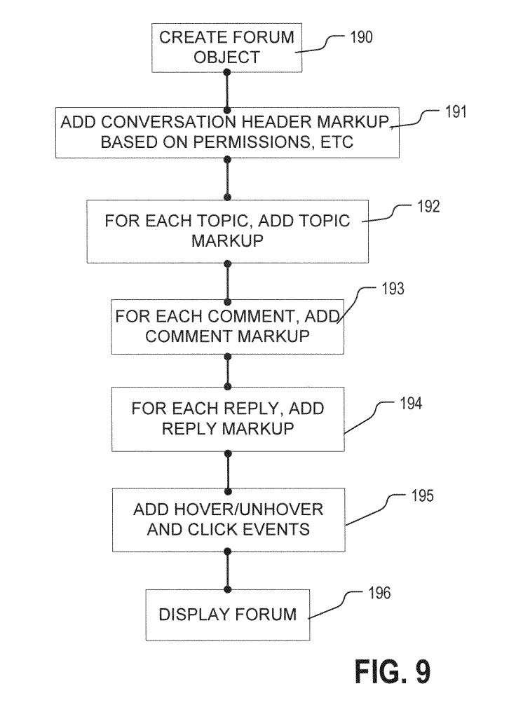

FIG. 9 is a representation of a forum object. A function is included for creating a forum object (190). A function is included for adding conversation header markup based on permissions of the user (191). A function is included for adding topic markup (192). A function is included for adding comment markup (193). The function is included for adding reply markup (194). The function is included for adding hover/unhover events and click events associated with the forum object (195). Finally, an object is included for displaying the forum (196).

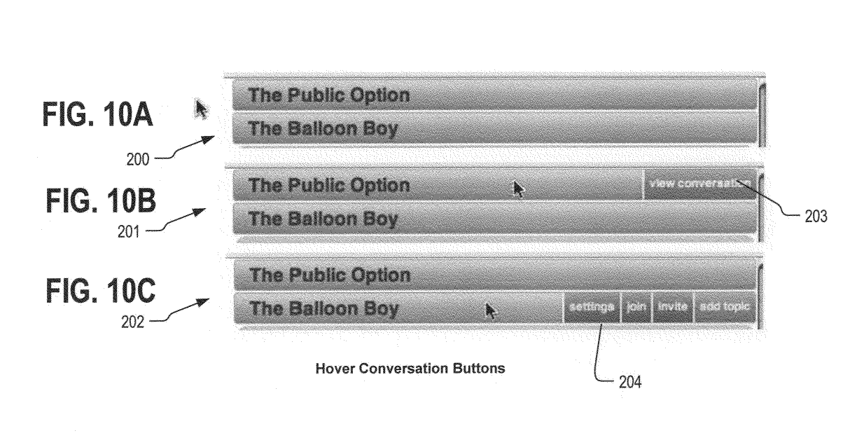

FIGS. 10A-10C illustrate a sequence of representations of a conversation header feature or a forum construct illustrating hover actions associated with the conversation header. FIG. 10A shows a conversation header feature 200 with a cursor positioned outside the header field. Hovering the cursor over the conversation bar feature causes display of buttons associated with that conversation. FIG. 10B shows the conversation header feature 201 with a cursor positioned over the top conversation bar. In this case, the conversation associated with that top conversation bar is a “closed” conversation, and the process presents a “view conversation” button 203. FIG. 10C shows the conversation header feature 202 with a cursor positioned over the bottom conversation bar. In this case, the conversation associated with the bottom conversation bar is an “open” conversation, and the process presents a set of buttons 204 including a button for showing “settings” of the conversation, a button for invoking a function to “join” the conversation, a button for invoking a function to “invite” other participants to join the conversation, and a button to invoke a function presenting a web form for adding a topic to the conversation. Moving the cursor position off of the conversation header cause the buttons to be hidden.

FIGS. 11A and 11B illustrate a sequence of representations of a topic field 215 in a forum construct. In FIG. 11A, representation 210 is shown, with a cursor positioned outside of the field. The topic field 215 includes nested comments as discussed above in connection with FIG. 3. FIG. 11B representation 211 is shown, with a cursor positioned over the topic field 215. As result, a function is executed to draw the “collapse” button 212 and the “add comment” button 213 on the topic field. The “add comment” button 213 is used to cause a function to present a web form for adding a comment linked to the topic. The “collapse” button 212 is used to cause a function to collapse the topic field 215 in order to hide the nested comments.

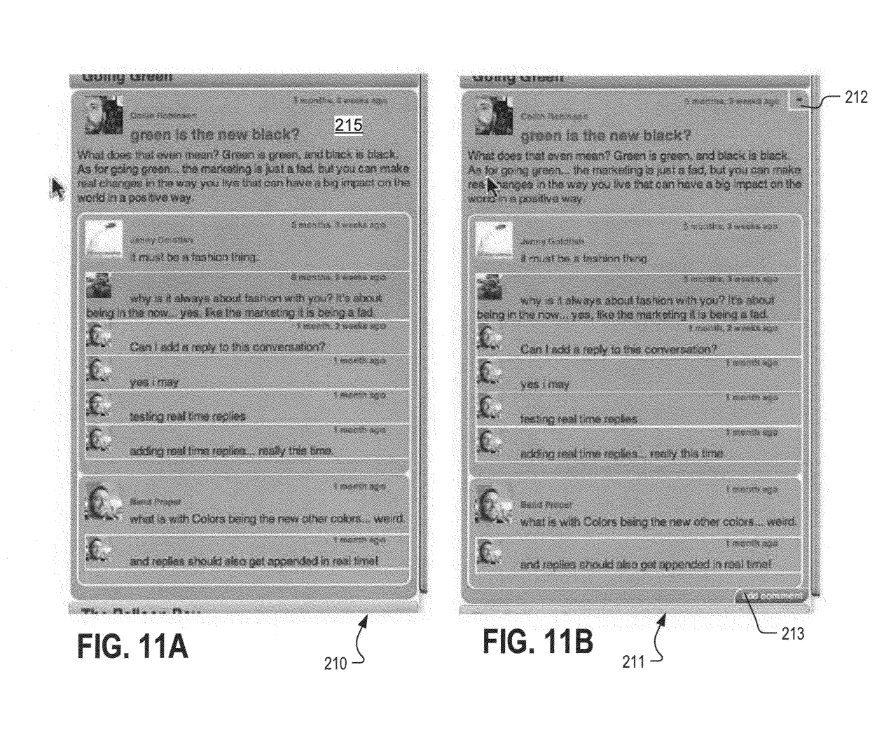

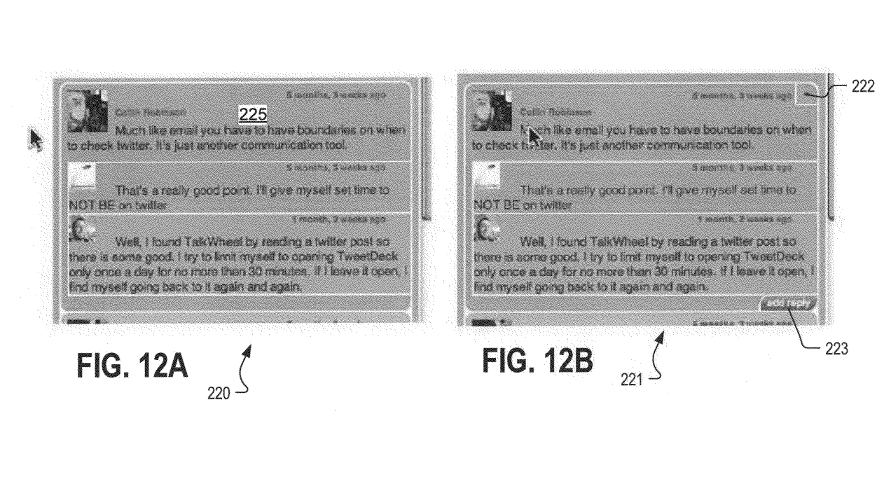

FIGS. 12A and 12B illustrate a sequence of representations of a topic field 215 in a forum construct. In FIG. 12A, representation 220 is shown, with a cursor positioned outside of the field. The comment field 225 includes nested replies as discussed above in connection with FIG. 3. FIG. 11B representation 221 is shown, with a cursor positioned over the comment field 225. As result, a function is executed to draw the “collapse” button 222 and the “add reply” button 223 on the common field. The “add reply” button 223 is used to cause a function to present a web form for adding a reply linked to the comment.

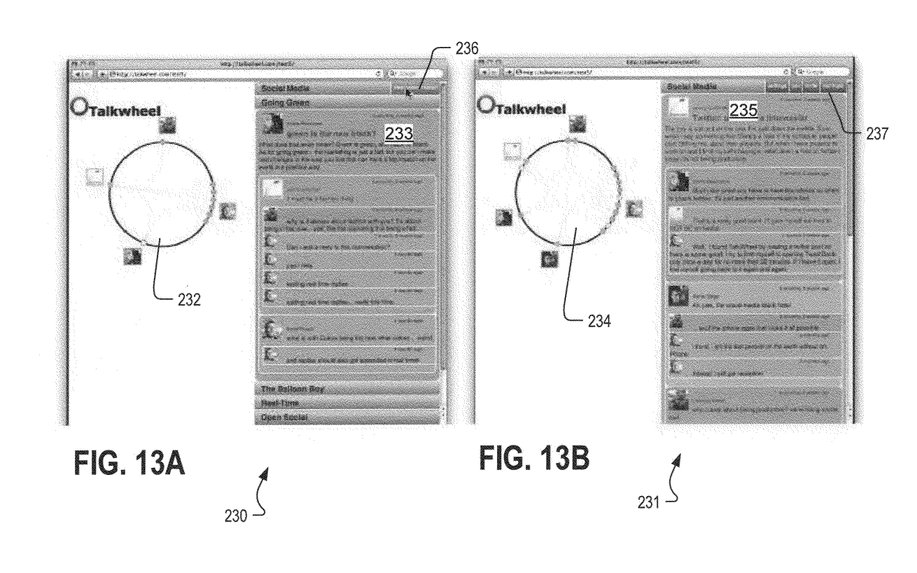

FIGS. 13A and 13B illustrate a sequence of representations of a user interface displaying a conversation image, and showing how a click operation on a “view conversation” button closes the current conversation and opens a new conversation. This action redraws both the forum and the wheel-like constructs. In FIG. 13A the representation 230 including a wheel-like construct 232 and a forum construct including topic field 233 is shown. In the forum construct a conversation “going green” is open, including a topic field 233 with nested replies as discussed above. A conversation bar including a “view conversation” button 236 is displayed over the conversation bar for the “going green” conversation. A cursor is shown positioned over the “view conversation” button 236. A click on the “view conversation” button 236 cause the “going green” conversation to collapse, and the “social media” conversation to expand to create a representation 231 as shown in FIG. 13B. Along with expanding the forum construct, including a comment field 235 with nested reply fields, for the “social media” conversation, a new wheel-like construct 234 the drawn for the open conversation. Also, a set 237 of buttons like that discussed above in connection with FIG. 10B on the conversation bar for the open conversation is created.

FIGS. 14A and 14B illustrate a sequence of representations of a user interface displaying a forum construct to illustrate the “add topic” function. In FIG. 14A, representation 240 shows a topic field 242 for a conversation, in which a set of buttons is displayed on the conversation bar, including the “add topic” button 243. As illustrated in FIG. 14A, a user positions the cursor over the “add topic” button 243 clicks. This results in generating the representation 241 shown in FIG. 14B. In FIG. 14B, a web form for a creating a request to post a topic is displayed, including a text entry field 244 for a “title” to be associated with the new topic, and a text entry field 245 for text to describe the new topic. Also the representation 241 shows a “cancel” button 246 and a “submit” button 247 associated with the web form for creating the request to post the topic. A click on the “cancel” button closes the web form without submitting the post. A click on the “submit” button causes a post request to be transmitted to the server-side resources for addition a topic level node to the data structure of the conversation. Also, the function associated with the “submit” button 247 can cause the animation loop to redraw the wheel-like construct and the forum construct.

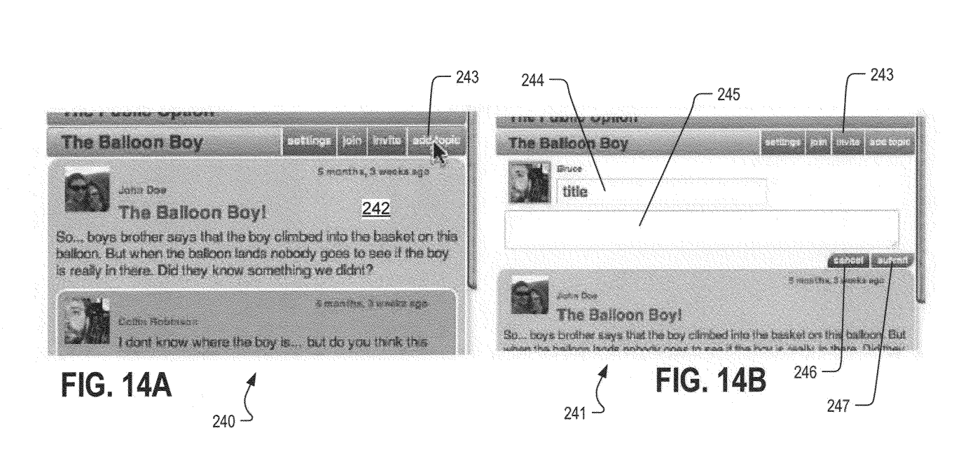

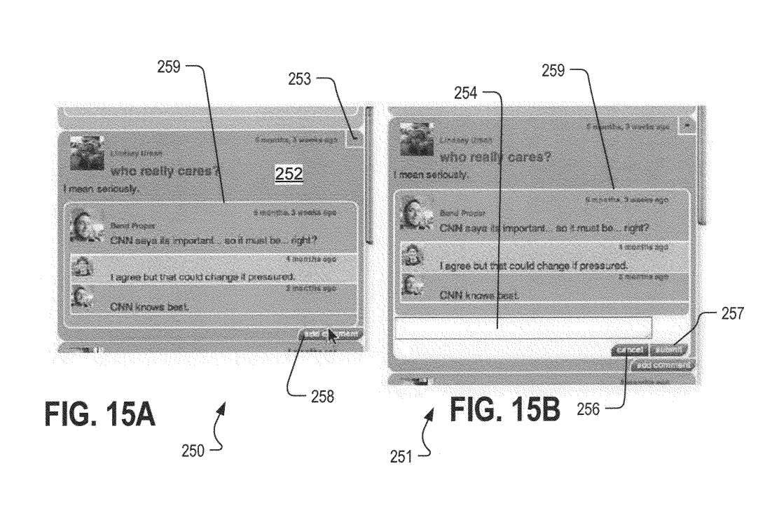

FIGS. 15A and 15B illustrate a sequence of representations of a user interface displaying a forum construct to illustrate the “add comment” function. In FIG. 15A, representation 250 includes an expanded topic field 252. Within the topic field 252, a “collapse” button 253 is provided in the upper right corner. The topic field 252 includes nested comments within a field 259. Also an “add comment” button 258 is drawn on the lower right portion of the topic field 252, and outside the nested comments field 259. As illustrated FIG. 15A, a user positions the cursor over the “add comment” button 258 and clicks to invoke the add comment function. This results in generating the representation 251 shown in FIG. 15B. In FIG. 15B, a web form for creating a request to post a comment is displayed inside the nested comment field 259 for the topic field 252, including a text entry field 254, along with a “cancel” button 256 and a “submit” button 257 associated with the web form for creating the request to post the comment. A click on the “cancel” button closes the web form without submitting the post. A click on the “submit” button causes a post request to be transmitted to the server-side resources for addition a comment level node-linked to the topic level node represented by field 252, into the data structure of the conversation. Also, the function associated with the “submit” button 257 can cause the animation loop to redraw the wheel-like construct and the forum construct.

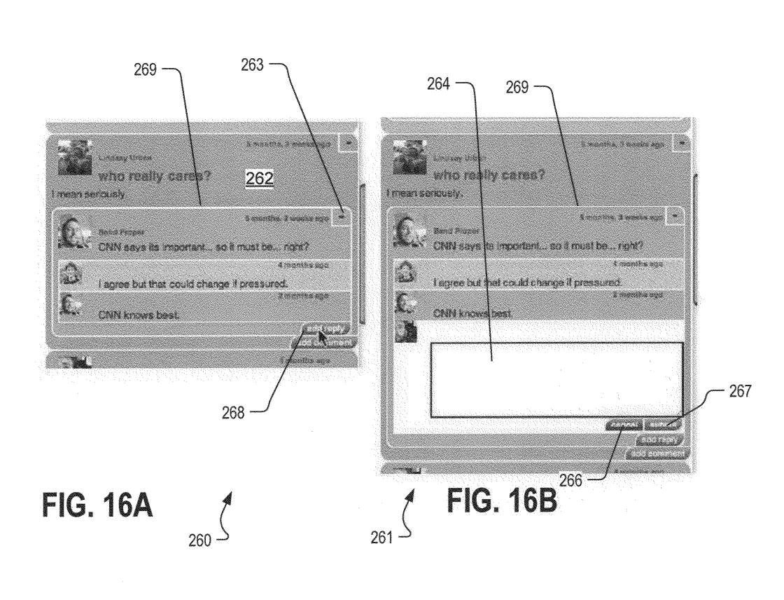

FIGS. 16A and 16B illustrate a sequence of representations of a user interface displaying a forum construct to illustrate the “add reply” function. In FIG. 15A, representation 260 includes an expanded comment field 262. Within the comment field 262, a “collapse” button 263 is provided in the upper right corner as a result of positioning the cursor over the topic field 262. The comment field 269 includes nested replies. Also an “add reply” button 268 is drawn on the lower right portion of the nested comment field 269, as a result of positioning the cursor over the comment field 269. As illustrated in FIG. 16A, a user positions the cursor over the “add reply” button 268 and clicks to invoke the add reply function. This results in generating the representation 261 shown in FIG. 16B. In FIG. 16B, a web form for creating a request to post a reply is displayed inside the nested comment field 269 for the topic field 262, including a text entry field 264, along with a “cancel” button 266 and a “submit” button 267 associated with the web form for creating the request to post the reply. A click on the “cancel” button closes the web form without submitting the post. A click on the “submit” button causes a post request to be transmitted to the server-side resources for addition of a reply level node-linked to the comment level node represented by field 262, into the data structure of the conversation. Also, the function associated with the “submit” button 267 can cause the animation loop to redraw the wheel-like construct and the forum construct.

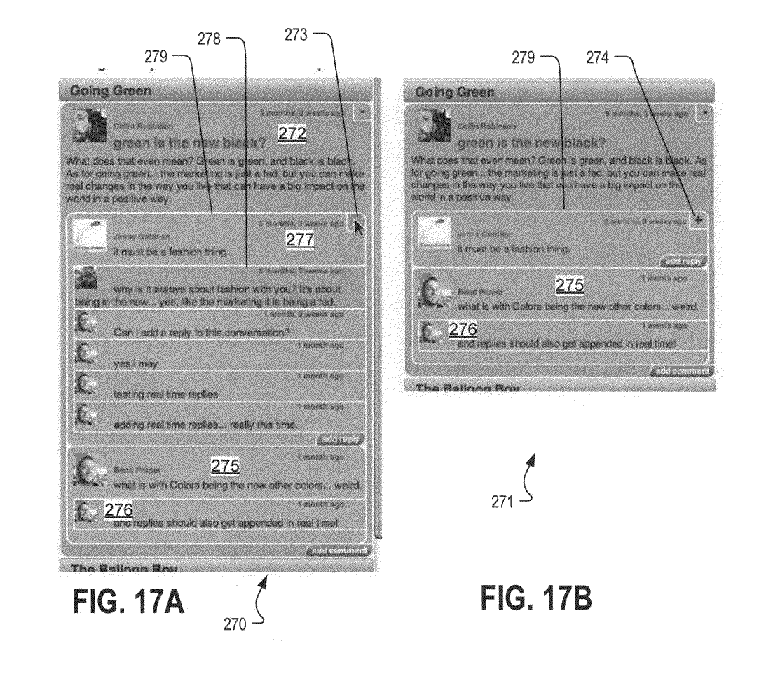

FIGS. 17A and 17B illustrate a sequence of representations of the user interface displaying a forum construct to illustrate the consequences of clicking a “collapse” button. In FIG. 17A, representation 270 includes a topic field 272 having a nested comments field 279. Nested comments field 279 is represented with a comment field 277 in expanded format, including nested reply field 278. Comment field 275 and comment field 276 are represented in the collapsed format. A “collapse” button 273 is presented in the upper right corner of the expanded comment field 277, as a result of the cursor hovering over the field. If the user clicks on the “collapse” button 273, a function is invoked to collapse the expanded comment field 277 and produce representation 271 illustrated in FIG. 17B. In FIG. 17B, the “collapse” button 273 is replaced with an “expand” button 274, and the expanded comment field 277 is collapsed resulting in removal of the nested reply field 278. As result of representing the comment field 277 in a collapsed form, the size of the nested comments field 279 within the topic is reduced in the representation 271, relative to the representation 270.

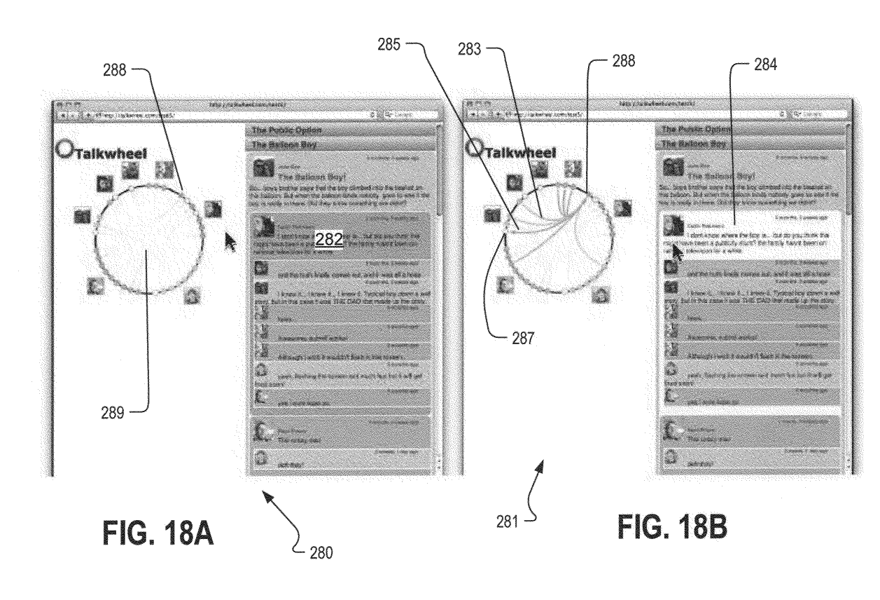

FIGS. 18A and 18B illustrate a sequence of representations of the user interface displaying the wheel-like construct and the forum construct, and illustrating the animation that results from hovering over a post in the forum construct. FIG. 18A illustrates a representation 280 including a wheel-like construct 289 and a forum construct associated with the wheel-like construct 289, which includes a conversation including a topic with a comment field 282. A corresponding feature 288 represents the comment level node in the data structure corresponding to the comment 282. Also, the color (blue in this example) of the feature 288 matches the color (blue in this example) of the background of the field 282 for the corresponding comment. In the representation 280, the position of the cursor is between the wheel-like construct 289 and the forum construct. In representation 281 shown in FIG. 18B, the cursor is positioned over the comment field 282. This results in highlighting the comment field 282 so it is represented by feature 284 in a highlighting color (white in this example). Also in association with highlighting the comment field 282 by feature 284, arrows 283 associated with the feature 288 are highlighted on the wheel-like construct, emphasizing the number of replies to the corresponding comment, as well as the users who created the replies. In addition, arrow 285 associated with feature 288 is highlighted on the wheel-like construct, linking the associated comment with its parent topic level node represented on the wheel-like construct by a feature 287. Arrows 283 and arrow 285 are color-coded, matching the colors associated with users who created lower-level nodes for the corresponding pair of posts, that is the replies in the case of arrows 283 and the comment in the case of arrow 285.

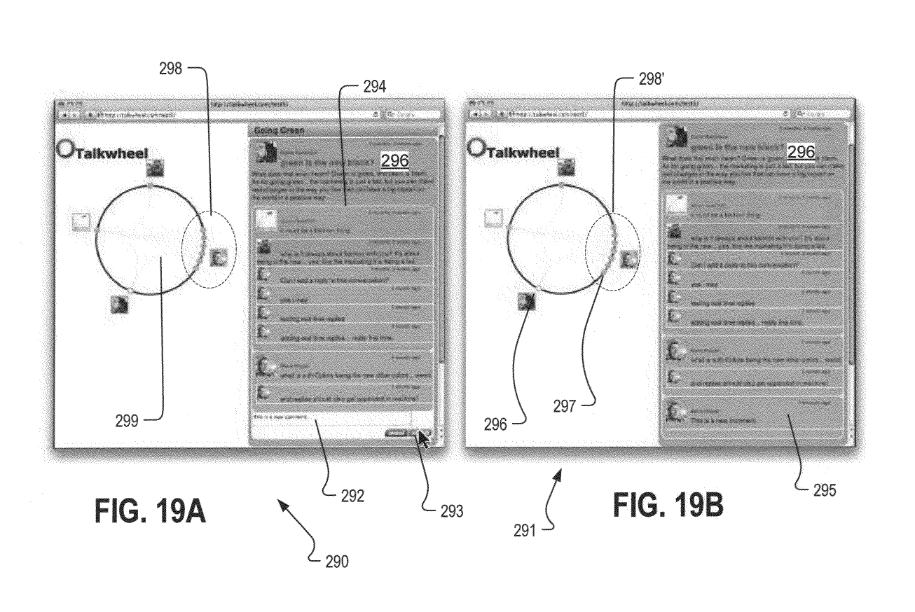

FIGS. 19A and 19B illustrate a sequence of representations of the user interface displaying the wheel-like construct and the forum construct, and illustrating animation that results from clicking a “submit” button when posting a new topic, comment or reply. The submit function generates a call to the back end server functions, such as an AJAX call, requesting that the post be added to the note-link structure. Upon adding a node, the wheel-like construct and the forum construct are redrawn to show the new post. The representation 290 shows a wheel-like construct 299 including a plurality of features in a group 298 associated with a specific user. In this example, there are six post level features in the group 298 associated with the user. The forum construct includes a blue topic field 296 in which a nested comment field 294 is expanded. A web form text field 292 has been opened for submitting a new comment within the topic field 296. Text has been entered in the field 292, and the user has position the cursor over a “submit” button 293. Upon clicking the “submit” button 293, the animation loop redraws the user interface to present the representation 291 as shown in FIG. 19B. The representation 291 includes a new comment field 295 which includes the text in the web form text field 292, associated with the user who created it and associated with the topic field 296. The representation 291 also includes an updated wheel-like construct 299. The update in this example results in adding an additional feature 297 to the group associated with the user, now labeled 298′. Also, an arrow is added linking the new feature 297 with the blue feature representing the topic within which it was created, associated with user 296.

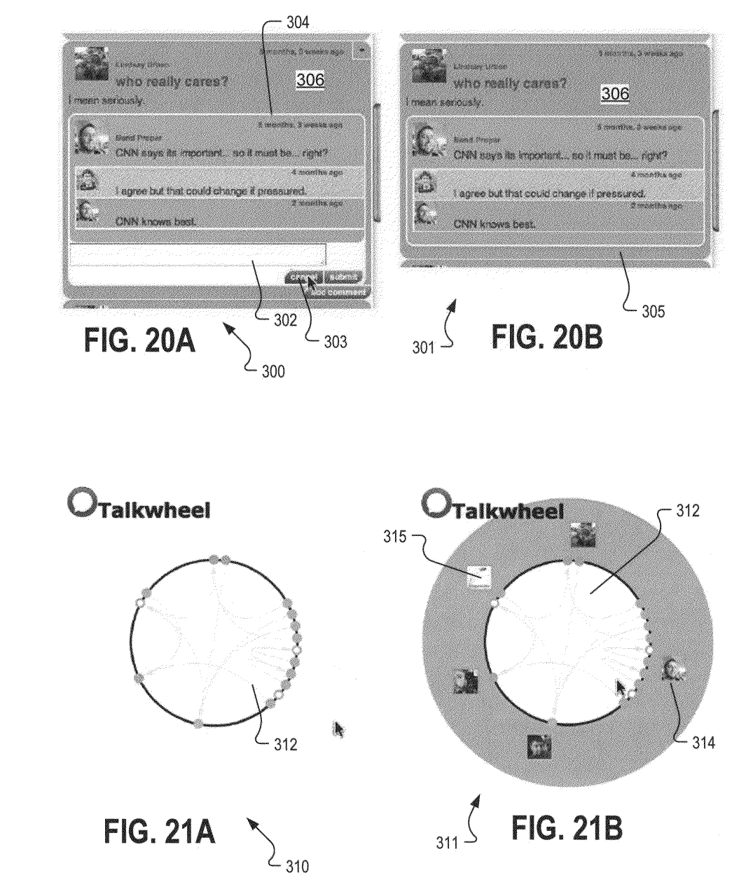

FIGS. 20A and 20B illustrate a sequence of representations of the user interface displaying the forum construct, showing animation that results from clicking the “cancel” button after a “new comment” function has been invoked to open a web form to create a new comment. The representation 300 shown in FIG. 20A illustrates a nested comment field 304 within a topic field 306. A web form including text field 302 is open as result of invoking the “add comment” function. The cursor is positioned over the “cancel” button 303. Upon clicking the “cancel” button 303, a function is executed to collapse the web form, resulting in the representation 301 shown in FIG. 20B. The representation 301 shows the topic field 306 with nested comments. The region 305 within the topic field 306 has been closed.

FIGS. 21A and 21B illustrate a sequence of representations of the user interface displaying the wheel-like construct, to show animation that results from hovering over the wheel-like construct. The representation 310 illustrates a wheel-like construct 312 in which the features representing comment level and reply level nodes in the node-link structure are positioned so that they have centers of area around the rim in groups by user as discussed above. The cursor is illustrated outside the wheel-like construct in the representation 310. As shown in FIG. 21B, the representation 311 results from positioning the cursor over the wheel-like construct 312. This results in redrawing the wheel-like construct to add features (e.g. 314, 315), referred to as user avatars herein, identifying the users associated with corresponding groups of comment and reply level nodes represented on the wheel-like construct.

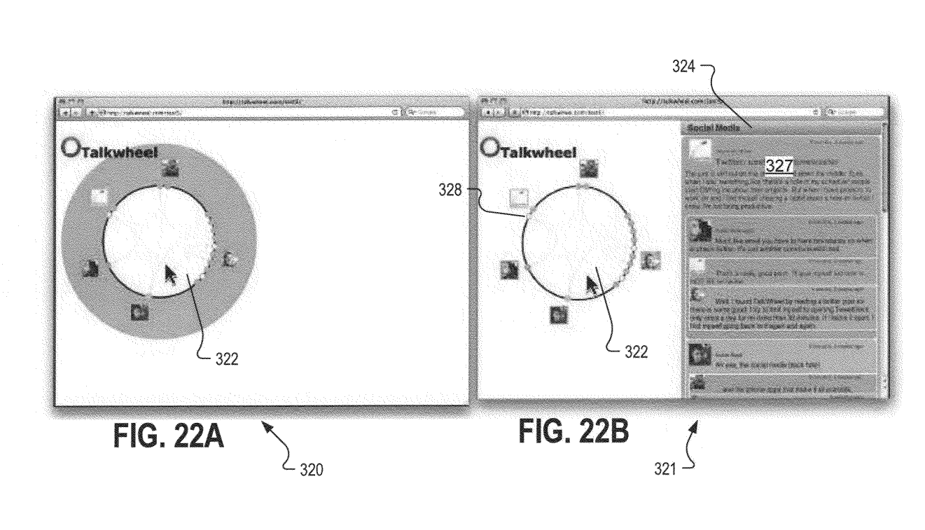

FIGS. 22A and 22B illustrate a sequence of representations of the user interface to show the animation which results from clicking on a position over the wheel-like construct. FIG. 22A shows a representation 320 including the wheel-like construct 322 over which the cursor is positioned in a form similar to that of FIG. 21B. FIG. 22B shows representation 321 with the cursor position over the wheel-like construct 322 after a click invokes the function to draw the forum construct including a conversation pane 324 associated with the wheel-like construct 322. As can be seen, a comment field 327 is illustrated which corresponds with, and has the same background color (green in this example) as, the comment feature 328 on the wheel-like construct 322.

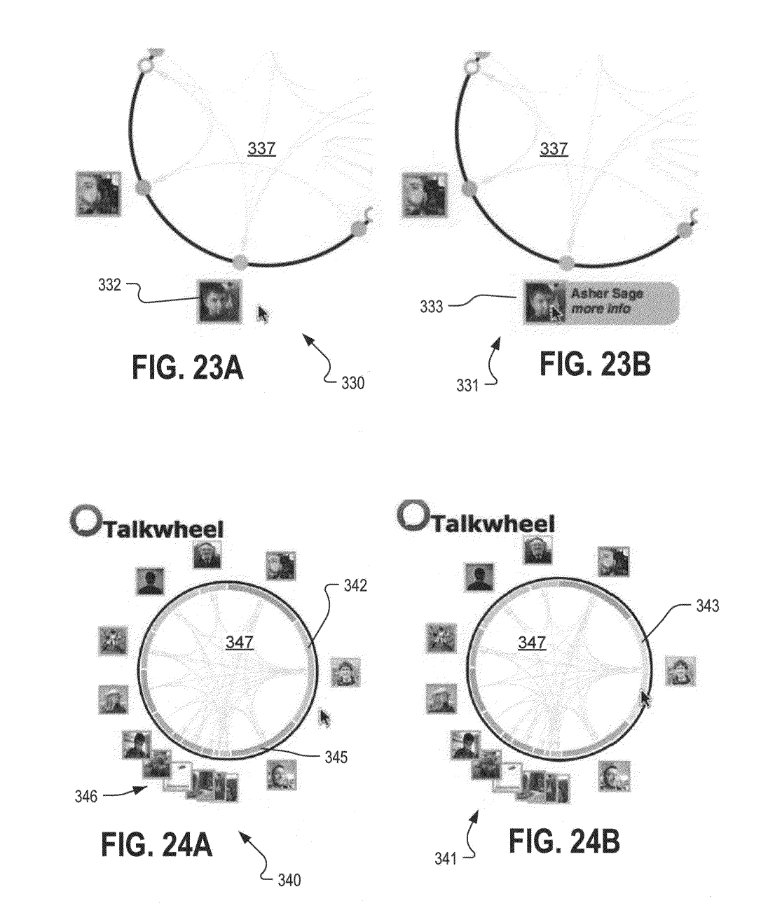

FIGS. 23A and 23B illustrate a sequence of representations of the user interface displaying the wheel-like construct 337 to show the animation which results from hovering the cursor over a user avatar feature. FIG. 23A illustrates representation 330 which includes a user avatar feature 332 associated with a post on the rim. The cursor is positioned adjacent the user avatar feature 332. FIG. 23B illustrates representation 331, which includes the expanded user avatar feature 333 in which the avatar is expanded to include a field providing text that can include information about the user.

FIGS. 24A and 24B illustrate a sequence of representations of the user interface displaying the wheel-like construct, showing a user arc feature which is presented in a compressed mode display where the number of comment and reply level nodes exceeds a threshold for the user, and showing the animation that results from hovering the cursor over a user arc feature. FIG. 24A shows representation 340 including a wheel-like construct 347. The wheel-like construct 347 illustrates a number of groups of nodes in the compressed format, including a user arc feature 342 and a number of other user arc features (e.g. 345) associated with respective users having corresponding user avatar features 346. In the representation 340, the cursor is positioned outside the wheel-like construct 347. The colors of the user arc features match the colors assigned to the users which created the group of nodes. The representation 341 shown in FIG. 24B illustrates the cursor positioned over the user arc feature 342, which is now redrawn as feature 343 in a highlighted color. This highlighting of the user arc feature 343 signals to the user that the arc feature has been selected by the position of the cursor, and that a click or other signal can invoke a function to expand the group.

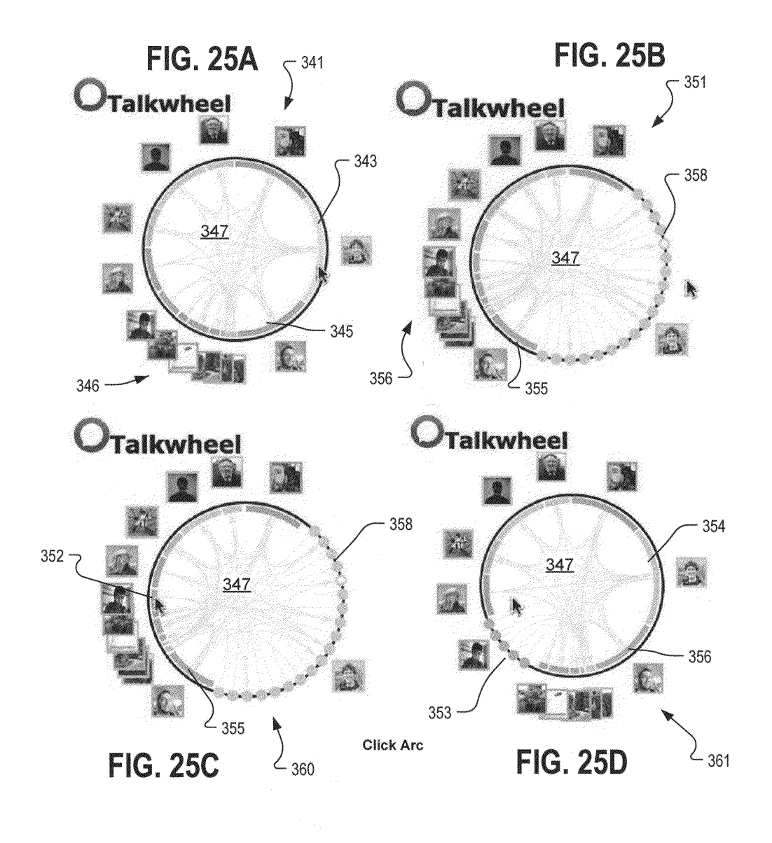

FIGS. 25A through 25D illustrate a sequence of representations of the user interface displaying the wheel-like construct, illustrating the animation that occurs upon clicking a user arc feature. FIG. 25A includes representation 341, like that of FIG. 24B, of a wheel-like construct 347 in which the cursor is positioned over a highlighted user arc feature 343. A number of additional user arc features, including user arc feature 345, are positioned around the wheel with corresponding user avatar features 346. Upon clicking on the highlighted user arc feature 343, a function is invoked to expand the group of comment level and reply level nodes associated with the compressed user arc feature 343, resulting in a group 358 of node features illustrated in the representation 351 of FIG. 25B. This results in redrawing the wheel-like construct, to change the sizes and positions of the user arc features to fit within the remaining space around the rim of the wheel-like construct 347. Thus, the feature 345 shown in representation 341 is redrawn as feature 355 covering a smaller arc on the rim in representation 351. Likewise, the user avatar features 356 are repositioned around the wheel to maintain their association with their respective groups of nodes.

FIG. 25C shows representation 360 of the wheel-like construct 347 illustrating movement of the cursor adjacent the user arc feature 352 corresponding to a different group of comment level and reply level nodes. FIG. 25D shows representation 361 of the wheel-like construct 347 after invoking a function that results from clicking on user arc feature 352. The function resulting from clicking on user arc feature 352 expands the group of nodes represented by user arc feature 352 to produce a group 353 of node features positioned around the rim of the wheel-like construct. Also, the group 358 of node features is collapsed into a new user arc feature 354. Also the wheel-like construct 347 is redrawn to reposition the user arc features and the group 353 of node level features around the wheel along with the user avatar features as illustrated.

FIGS. 26A and 26B illustrate a sequence of representations of the user interface displaying the wheel-like construct and the forum construct together, illustrating the animation that occurs upon hovering over a specific post level node on the wheel-like construct. FIG. 26A shows representation 370 which includes wheel-like construct 377 and forum pane 375. The cursor is positioned outside the wheel-like construct 377. FIG. 26B illustrates the representation 371 in which the cursor is positioned over a specific post level node feature 373. The hovering action with the cursor results in a text balloon 376 which includes an excerpt of the corresponding post. In addition, the hovering action results in arrow features (e.g. 379) highlighting the links associated with the post level node, including in the case of highlighting a comment level node, an arrow representing a link to its topic (upper) level node and arrows representing links to its reply (lower) level nodes are highlighted, and color-coded according to the user who created the lower-level node on the link. Also, the hovering action with the cursor results in highlighting of the field 378 in the forum construct that corresponds with the highlighted node feature on the wheel-like construct 377, facilitating navigation by the user between the wheel-like construct and the forum construct.

FIGS. 27A and 27B illustrate a sequence of representations of the user interface displaying the wheel-like construct and forum construct together, illustrating the result of the function invoked by clicking on a post feature on the wheel-like construct. FIG. 27A illustrates a representation 380 in which the wheel-like construct 387 is shown in association with its corresponding forum construct 385. The cursor is positioned over a specific node on the wheel-like construct. As discussed with reference to FIGS. 26A and 26B the hovering results in displaying of a balloon feature and highlighting of the corresponding field in the forum construct 385. However, if the corresponding field in the forum construct does not fall within the field of view shown on the display, then clicking on the node feature 383 on the wheel-like construct causes a representation 381 to be generated and displayed as shown in FIG. 27B. In representation 381, the forum construct has been scrolled, so that the highlighted field 388 corresponding with the node feature 383 on the wheel-like construct, is positioned within the field of view on the display.

Technology is provided presenting a non-linear interface for interacting with complex data structures. As applied to a discussion platform, the technology captures group dynamics online. Representations of the node-link structure divided display multiple variables in one diagram including time. Updates of the representations of the node-link structure can be executed in real-time. Features on the representations can be supplemented with pointer activated functions that relate elements to one another. Color relationships can be used as well to illustrate relationships among features of the display. The arrangements provided enable a user to filter cluster data in a way that highlights the most relevant information.

The upper-level node feature described herein as a wheel-like construct, can be implemented so that it expands and grows to show tangential information. Arrows can be used to show relationships between items on the display. Arrow shading, density, and line weight can vary to show relevance. For example, darker color is utilized to indicate a higher degree of relevance, or a color can be changed to categorize relationships on the screen. The representations of the node-link structure can be used to show the history of a updates to the structure, such as the history of a discussion on discussion platform.

Visualization and interaction tools described here can be used for group discussions, analytics, monitoring, correlating data, clearly mapping relationships among data, visualizing trends, facilitating online classes, electronic learning, online dating, electronic commerce, organizing search results, organizing the outputs of physical sensors, and other processes for navigating information.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A method executed by a data processor, comprising:
obtaining node-link data defining a node-link structure including at least an upper-level node on an upper-level of the node-link structure, an intermediate-level node and a lower-level node; the node-link structure including links relating at least two of the nodes, and at least intermediate and lower nodes having a source parameter indicating a source of data in the node; and
using the node-link data to present a sequence of representations of the node-link structure on a display;
each representation in the sequence including an upper-level node feature perceptible on the display representing an upper-level node, one or more intermediate-level node features perceptible on the display representing respective intermediate nodes, and one or more lower-level node features perceptible on the display representing respective lower-level nodes;
the upper-level node feature representing an upper-level node including a rim;
the one or more intermediate node features representing respective intermediate nodes linked to the upper-level node, and having centers of area positioned on the display along the rim;
the one or more lower-level node features representing respective lower-level nodes being linked to corresponding intermediate-level nodes of the one or more intermediate-level nodes, and having centers of area positioned on the display along the rim; and
the lower-level node features and intermediate-level node features being positioned along the rim in the display according to the source parameter, so that intermediate-level node features and lower-level node features representing nodes in the node-link structure having a particular source parameter are perceptible as a group positioned along the rim on the display.

2. The method of claim 1, wherein at least one representation in the sequence includes:
at least one link feature perceptible on the display representing a link between a particular lower-level node and a particular intermediate-level node, the link feature having a proximal end positioned near one of the lower-level node features representing the particular lower-level node and the group if any of which the lower-level node feature is a member, and having a distal end positioned near one of the intermediate-node features representing the particular intermediate-level node and the group if any of which the intermediate-level node feature is a member.

3. The method of claim 2, including providing with said at least one representation in the sequence a pointer activated function associated with one or more of said intermediate-level node features and lower-level node features, which upon activation over a particular intermediate or lower-level node feature associated with the link feature, causes presentation of another representation in said sequence in which the link feature is changed.

4. The method of claim 1, wherein intermediate-level node features comprise a first icon, and lower-level node features comprise a second icon perceptible as different from the first icon on the display.

5. The method of claim 1, wherein intermediate-level node features comprise a first icon having an area on the display, and lower-level node features comprise a second icon perceptible as different from the first icon on the display and having an area on the display perceptible as equivalent to the area of the first icon.

6. The method of claim 1, wherein at least one representation in the sequence includes a group feature representing a group including a number N of intermediate node features and lower-level node features positioned on the rim, the group feature being perceptible on the display as covering an arc along the perimeter indicative of the number N.

7. The method of claim 6, including providing with said at least one representation in the sequence, a pointer activated function associated with the group feature, which upon activation over the group feature, causes presentation of another representation in said sequence in which the group feature is replaced by the number N of intermediate node features and lower-level node features grouped along the rim.

8. The method of claim 1, wherein at least one representation in the sequence includes a source feature representing a particular source parameter, and having a center of area on the display outside the rim and perceptible as associated with the group associated with the particular source parameter.

9. The method of claim 1, wherein the node-link structure includes at least one additional level node having a source parameter, and linked to a particular lower-level node of the one or more lower-level nodes, and at least one of the representations in the sequence includes an additional level node feature representing the additional level node and having a center of area positioned on the display along the rim according to the source parameter and perceptible as a member of a group positioned along the rim on the display.

10. The method of claim 9, including a link feature perceptible on the display representing a link between the additional level node and the particular lower-level node, the link feature having a proximal end positioned near one of the additional level node features representing the additional level node and the group if any of which the additional level node feature is a member, and having a distal end positioned near one of the lower node features representing the particular lower-level node and the group if any of which the lower-level node feature is a member.

11. The method of claim 1, wherein at least one representation in the sequence includes a graphical construct, the graphical construct comprising a pane corresponding with the upper-level node and fields within the pane corresponding with one or more of the intermediate-level nodes and lower-level nodes, the fields including representations of contents of the corresponding nodes.

12. The method of claim 11, including providing with said at least one representation in the sequence including a graphical form providing an interface for creating post requests by which updates to the node-link structure may be requested, and including upon posting an update to the node-link structure in response to a post request created using the interface, causing presentation of another representation in the sequence including a feature corresponding to the update.

13. The method of claim 11, wherein providing with said at least one representation in the sequence including a graphical construct, a pointer activated function associated with one or more of said intermediate-level node features and lower-level node features, which upon activation over a particular intermediate or lower-level node feature, causes presentation of another representation in said sequence in which a feature of one of the fields within the pane is changed, where the changed one of the fields corresponds with the particular intermediate or lower-level node feature.

14. The method of claim 11, wherein the contents of the intermediate-level nodes and the lower-level nodes in the node-link data comprise communications created by users, and the source parameters identify the users.

15. The method of claim 1, including providing with at least one representation in the sequence, a pointer activated function associated with the upper-level node feature, which upon activation, causes presentation of another representation in the sequence including a graphical construct, the graphical construct comprising a pane corresponding with the upper-level node represented by the upper-level node feature, and fields within the pane corresponding with one or more of the intermediate-level nodes and lower-level nodes, the fields including representations of contents of the corresponding nodes.

16. The method of claim 1, including after presenting at least one representation in the sequence, obtaining a change in the node-link data, and wherein at least one representation in the sequence includes at least one of an additional lower-level node feature positioned along the rim and an additional intermediate-level node feature positioned along the rim and representing the change in the node-link data.

17. The method of claim 1, wherein the sequence begins with a first representation and ends with a last representation, the last representation being perceptible as a changed continuation of the first representation.

18. A computer system, comprising:
a data processor, including memory and a communication interface, the memory including instructions executable by the data processor, the instructions including logic to maintain one or more node-link structures, the one or more node-link structures respectively including at least an upper-level node, an intermediate-level node and a lower-level node; the one or more node-link structures including links relating at least two of the nodes of the corresponding node-link structure, and at least intermediate and lower nodes having respective source parameters indicating respective sources of data in the nodes; and
logic to communicate with clients via the communication interface, including logic to provide node-link data to the clients in response to requests for node-link data, and logic to provide executable data to the clients supporting use of the node-link data to present a sequence of representations of the node-link structure on a display controlled by the client;
each representation in the sequence including an upper-level node feature perceptible on the display representing an upper-level node, one or more intermediate-level node features perceptible on the display representing respective intermediate nodes, and one or more lower-level node features perceptible on the display representing respective lower-level nodes;
the upper-level node feature representing an upper-level node including a rim;
the one or more intermediate node features representing respective intermediate nodes linked to the upper-level node, and having centers of area positioned on the display along the rim;
the one or more lower-level node features representing respective lower-level nodes being linked to corresponding intermediate-level nodes of the one or more intermediate-level nodes, and having centers of area positioned on the display along the rim; and
the lower-level node features and intermediate-level node features being positioned along the rim in the display according to the source parameter, so that intermediate-level node features and lower-level node features representing nodes in the node-link structure having a particular source parameter are perceptible as a group positioned along the rim on the display.

19. The computer system of claim 18, wherein at least one representation in the sequence includes:
at least one link feature perceptible on the display representing a link between a particular lower-level node and a particular intermediate-level node, the link feature having a proximal end positioned near one of the lower-level node features representing the particular lower-level node and the group if any of which the lower-level node feature is a member, and having a distal end positioned near one of the intermediate node features representing the particular intermediate-level node and the group if any of which the intermediate-level node feature is a member.

20. The computer system of claim 19, wherein the executable data supporting use of the node-link data to present a sequence of representations includes logic to provide with said at least one representation in the sequence a pointer activated function associated with one or more of said intermediate-level node features and lower-level node features, which upon activation over a particular intermediate or lower-level node feature associated with the link feature, causes presentation of another representation in said sequence in which the link feature is changed.

21. The computer system of claim 18, wherein intermediate-level node features comprise a first icon, and lower-level node feature comprise a second icon perceptible as different from the first icon on the display.

22. The computer system of claim 18, wherein intermediate-level node features comprise a first icon having an area on the display, and lower-level node feature comprise a second icon perceptible as different from the first icon on the display and having an area on the display perceptible as equivalent to the area of the first icon.

23. The computer system of claim 18, wherein at least one representation in the sequence includes a group feature representing a group including a number N of intermediate node features and lower-level node features positioned on the rim, the group feature being perceptible on the display as covering an arc along the perimeter indicative of the number N.

24. The computer system of claim 23, wherein the executable data supporting use of the node-link data to present a sequence of representations includes logic to provide with said at least one representation in the sequence, a pointer activated function associated with the group feature, which upon activation over the group feature, causes presentation of another representation in said sequence in which the group feature is replaced by the number N of intermediate node features and lower-level node features grouped along the rim.

25. The computer system of claim 18, wherein at least one representation in the sequence includes a source feature representing a particular source parameter, and having a center of area on the display outside the rim and perceptible as associated with the group associated with the particular source parameter.

26. The computer system of claim 18, wherein the node-link structure includes at least one additional level node having a source parameter, and linked to a particular lower-level node of the one or more lower-level nodes, and at least one of the representations in the sequence includes an additional level node feature representing the additional level node and having a center of area positioned on the display along the rim according to the source parameter and perceptible as a member of a group positioned along the rim on the display.

27. The computer system of claim 26, wherein said at least one of the representations includes a link feature perceptible on the display representing a link between the additional level node and the particular lower-level node, the link feature having a proximal end positioned near one of the additional level node features representing the additional level node and the group if any of which the additional level node feature is a member, and having a distal end positioned near one of the lower node features representing the particular lower-level node and the group if any of which the lower-level node feature is a member.

28. The computer system of claim 18, wherein at least one representation in the sequence includes a graphical construct, the graphical construct comprising a pane corresponding with the upper-level node and fields within the pane corresponding with one or more of the intermediate-level nodes and lower-level nodes, the fields including representations of contents of the corresponding nodes.

29. The computer system of claim 28, wherein the executable data supporting use of the node-link data to present a sequence of representations includes logic to provide said at least one representation in the sequence including a graphical form providing an interface for creating post requests by which updates to the node-link structure may be requested, and which upon posting an update to the node-link structure in response to a post request created using the interface, causes presentation of another representation in the sequence including a feature corresponding to the update.

30. The computer system of claim 28, wherein the executable data supporting use of the node-link data to present a sequence of representations includes logic to provide said at least one representation in the sequence including a graphical construct, a pointer activated function associated with one or more of said intermediate-level node features and lower-level node features, which upon activation over a particular intermediate or lower-level node feature causes presentation of another representation in said sequence in which a feature of one of the fields within the pane is changed, where the changed one of the fields corresponds with the particular intermediate or lower-level node feature.

31. The computer system of claim 28, wherein the contents of intermediate-level nodes and the lower-level nodes in the node-link data comprise communications received via the communication interface from users, and the source parameters identify the users.

32. The computer system of claim 18, wherein the executable data supporting use of the node-link data to present a sequence of representations includes logic to provide with at least one representation in the sequence, a pointer activated function associated with the upper-level node feature, which upon activation over a particular intermediate or lower-level node feature, causes presentation of another representation in the sequence including a graphical construct, the graphical construct comprising a pane corresponding with the upper-level node represented by the upper-level node feature, and fields within the pane corresponding with one or more of the intermediate-level nodes and lower-level nodes, the fields including representations of contents of the corresponding nodes.

33. The computer system of claim 18, wherein the executable data supporting use of the node-link data to present a sequence of representations includes logic which after presenting at least one representation in the sequence, obtains a change in the node-link data, and wherein at least one representation in the sequence includes at least one of an additional lower-level node feature positioned along the rim and an additional intermediate-level node feature positioned along the rim and representing the change in the node-link data.

34. The computer system of claim 18, wherein the sequence begins with a first representation and ends with a last representation, the last representation being perceptible as a changed continuation of the first representation.

35. A data structure stored in a computer readable medium, the data structure including markup language instructions and embedded scripts of instructions, or links to scripts of instructions, executable by a computer, to implement processes comprising:
obtaining node-link data defining a node-link structure including at least an upper-level node on an upper-level of the node-link structure, an intermediate-level node and a lower-level node; the node-link structure including links relating at least two of the nodes, and at least intermediate and lower nodes having a source parameter indicating a source of data in the node; and
using the node-link data to present a sequence of representations of the node-link structure on a display;
each representation in the sequence including an upper-level node feature perceptible on the display representing an upper-level node, one or more intermediate-level node features perceptible on the display representing respective intermediate nodes, and one or more lower-level node features perceptible on the display representing respective lower-level nodes;
the upper-level node feature representing an upper-level node including a rim;
the one or more intermediate node features representing respective intermediate nodes linked to the upper-level node, and having centers of area positioned on the display along the rim;
the one or more lower-level node features representing respective lower-level nodes being linked to corresponding intermediate-level nodes of the one or more intermediate-level nodes, and having centers of area positioned on the display along the rim; and
the lower-level node features and intermediate-level node features being positioned along the rim in the display according to the source parameter, so that intermediate-level node features and lower-level node features representing nodes in the node-link structure having a particular source parameter are perceptible as a group positioned along the rim on the display.

36. The data structure of claim 35, wherein at least one representation in the sequence includes:
at least one link feature perceptible on the display representing a link between a particular lower-level node and a particular intermediate-level node, the link feature having a proximal end positioned near one of the lower-level node features representing the particular lower-level node and the group if any of which the lower-level node feature is a member, and having a distal end positioned near one of the intermediate node features representing the particular intermediate-level node and the group if any of which the intermediate-level node feature is a member.

37. The data structure of claim 35, the processes including providing with at least one representation in the sequence, a pointer activated function associated with the upper-level node feature, which upon activation over a particular intermediate or lower-level node feature, causes presentation of another representation in the sequence including a graphical construct, the graphical construct comprising a pane corresponding with the upper-level node represented by the upper-level node feature, and fields within the pane corresponding with one or more of the intermediate-level nodes and lower-level nodes, the fields including representations of contents of the corresponding nodes.

38. The data structure of claim 35, wherein at least one representation in the sequence includes a group feature representing a group including a number N of intermediate node features and lower-level node features positioned on the rim, the group feature being perceptible on the display as covering an arc along the perimeter indicative of the number N.

39. The data structure of claim 38, the processes including providing with said at least one representation in the sequence, a pointer activated function associated with the group feature, which upon activation over the group feature, causes presentation of another representation in said sequence in which the group feature is replace by the number N of intermediate node features and lower-level node features grouped along the rim.

40. The data structure of claim 35, the processes including after presenting at least one representation in the sequence, obtaining a change in the node-link data, and wherein at least one representation in the sequence includes at least one of an additional lower-level node feature positioned along the rim and an additional intermediate-level node feature positioned along the rim and representing the change in the node-link data.

41. The data structure of claim 35, wherein the sequence begins with a first representation and ends with a last representation, the last representation being perceptible as a changed continuation of the first representation.
